(19) United States
(12) Patent Application Publication
(10) Pub. No.: US 2025/0282591 A1
(43) Pub. Date: Sep. 11, 2025

(54) Methods and Apparatus for Using Lights to Indicate Detection of Obstacles By a Robotic Device Such as an Autonomous Material Handling Vehicle

(71) Applicant: Third Wave Automation, Inc., Union City, CA (US)

(72) Inventors: Matthew J. Willis, San Rafael, CA (US); Julian Mason, Redwood City, CA (US); Junha Roh, San Jose, CA (US); Stefan Ganchev, San Francisco, CA (US)

(21) Appl. No.: 19/074,422

(22) Filed: Mar. 9, 2025

Related U.S. Application Data
(60) Provisional application No. 63/563,359, filed on Mar. 9, 2024.

(51) Int. Cl. B66F 9/075; B66F 9/06

(52) U.S. Cl. CPC B66F 9/0755; B66F 9/063

(57) ABSTRACT

A light array, e.g., string or bar of lights, is used as an obstacle detection indicator with the lights being arranged on one or more sides of a robotic device. The indication of a detected object, through the use of one or more lights facing in the direction of the detected obstacle provide a visual signal that can be easily perceived by a human in the area of the robotic device. The robotic device may be an autonomous, semi-autonomous, or remotely controlled material handling vehicle, e.g., a robotic forklift. Light is emitted from the robotic device, e.g., via lights facing the direction of a detected obstacle to signal that the obstacle has been detected and the determined distance to the detected obstacle. In this way the obstacle detector indicator light provides an observer with a visible indicator that the system is aware of the presence of the detected obstacle.

### RELATED APPLICATIONS

The present application claims the benefit of U.S. Provisional Patent Application 63/563,359 which was filed Mar. 9, 2023 and which is hereby expressly incorporated by reference in its entirety.

### FIELD

The present application relates to robotic devices, e.g., autonomous material handling vehicles such as forklifts, and more particularly, to methods and apparatus for visually indicating detection of one or more obstacles by a robotic device.

### BACKGROUND

In many current robotic devices, e.g., autonomous material handling vehicles, it is not possible for those operating around the vehicle to know if they have in fact been seen by the vehicle. In manual operations (non autonomous) human-to-human signals (such as making eye contact) are often relied upon to acknowledge presence and signal to others that they have been seen by the human operator when the human operator is operating the vehicle.

It would be desirable if a simple way could be developed to signal to workers, e.g., humans, in an area in which a robotic device is autonomously working, that they have been detected and that the device is aware of their presence.

### SUMMARY

A light array, e.g., string or bar of lights, used as obstacle detection indicators, are arranged on one or more sides of a robotic device, e.g., in a row at one or more locations on the body of the robotic device. The robotic device may be, and sometimes is, an autonomous, semi-autonomous, or remotely controlled material handling vehicle, e.g., a robotic forklift or semi-autonomous forklift which can be remotely controlled under some circumstances. Lighting signals are used to indicate the detection of specific obstacles seen by the robotic device implementing the invention. The lighting implementation provides a feedback mechanism for those observing the vehicle, e.g., human workers in the area of the vehicle or human observers remotely monitoring the vehicle by the use of one or more cameras, to be made aware of the obstacle detection status of the robotic device.

Light is emitted from the robotic device, e.g., via lights facing the direction of a detected obstacle to signal that the obstacle has been detected and the determined distance to the detected obstacle. In this way the obstacle detector indicator light provides an observer a visible indicator that the system is aware of the presence of the detected obstacle when other methods would not be practical or appropriate to notify the observer that the obstacle has been detected. In at least some cases the obstacle is a human worker in the area of the robotic device.

In some embodiments the type of obstacle which is detected is determined, e.g., using known object recognition algorithms, and the light is controlled as a function of the type of detected object, e.g., a different color can be used to signal detection of a human than the color used to signal detection of an inanimate object.

The indication of a detected object through the use of one or more lights facing in the direction of the detected obstacle, e.g., object, provides a visual signal that can be easily perceived by a human in the area of the robotic device in a similar way that visual signs from a human operator can signal that a human operator is aware of the person working in the area. Thus, the invention mimics the use of visual indication of obstacle detection by a human vehicle operator, through the use of directional lighting highlighting which obstacles are in view, where they are being observed, and how far away they are from the vehicle without the need for a human operator to be involved in the signaling of such information.

While visual indicators of obstacle detection can be useful to signal detection of an obstacle, the lack of a visible obstacle indication, when an observer can see an obstacle in the area of the robotic device, allows the observer to determine that the robotic device's obstacle detection system has failed or may not be working properly. Thus, the methods are not only useful in signaling obstacle detection but can also be useful in identifying or detecting problems with the obstacle detection system.

In some embodiments, as the robotic device/vehicle position and/or obstacle position change relative to each other, the lights, e.g., LEDs, on the light bar track and display the relative position between the vehicle and the obstacle in real time. The lights can, and in some embodiments do, signal both distance and bearing to a detected obstacle. Distance to an obstacle can be, and sometimes is, indicated by the number of lights illuminated as a set, e.g., with the nearer a detected obstacle is to the device the greater the number of adjacent lights, e.g., LEDs, in the direction of the obstacle which are illuminated. Direction of the obstacle can be, and sometimes is, indicated by the center of the illuminated lights, e.g., LEDs, corresponding to an obstacle being in the direction of the obstacle. The intensity, color or hue can be used to create a perceived arrow or direction indicator pointing in the direction of the detected obstacle, e.g., with the center of the arrow being made brighter than the outer lights of the group of lights being used to point in the direction of the obstacle. In some embodiments a color is used to indicate the type of obstacle that was detected, e.g., with orange being used to indicate a human and red or another color being used to indicate other objects. The particular color used to indicate each different type of object can vary depending on the implementation.

While various features and embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of a system implemented in accordance with one exemplary embodiment.

FIG. 2 illustrates an exemplary operator workstation that can be used as any of the operator workstations shown in FIG. 1.

FIG. 3 illustrates an exemplary robotic device, e.g., a forklift which can operate autonomously, signals obstacle detection through the use of lights mounted on the robotic device, and in some embodiments includes a sensor for detecting when a pallet is properly nested on the forks of the robotic device.

FIG. 4 is a block diagram of the exemplary device of FIG. 3, which includes an obstacle detection indicator light bar and pallet position sensor.

FIG. 5 is a flow chart showing the steps of an exemplary method implemented by an exemplary robotic device, such as the one shown in FIG. 3 or of any one of the other figures, used to detect obstacles and visually indicate obstacle detection information through the use of lights.

FIG. 6 shows an exemplary robotic device including obstruction detection indicator lights along a canopy and which includes a pallet position sensor in addition to a forward looking camera array.

FIG. 7 is a view of the robotic device of FIG. 6 from which the rear of the robotic device can be seen with the obstruction detection indicator lights along the rear of the canopy being visible.

FIG. 8 illustrates an exemplary robotic device in which an obstruction detection indicator light array is positioned along the top of the main body of the robotic device.

FIG. 9 is a view of the robotic device of FIG. 8 from which the rear of the robotic device can be seen with the obstruction detection indicator lights along the rear of the main body and rear door are visible.

FIG. 10 is a flow chart showing the steps of an exemplary method for controlling a robotic device to perform a pick operation, e.g., a pallet pick up operation.

FIG. 11 shows an example robotic device, e.g., robotic forklift, and fork distance associated with the robotic forklift.

FIG. 12 shows the forks of the robotic device of FIG. 11 in an extended position and the extension distance E that can be achieved by extending the forks in the exemplary embodiment.

FIG. 13 shows the robotic forklift of FIG. 11 on level ground in position to initiate a pallet pick up operation.

FIG. 14 shows the robotic forklift of FIG. 11 on level ground with the forks extended as part of a pallet pick up operation with the pallet being nested in the forks and ready for lifting from the ground.

FIG. 15 shows the robotic forklift of FIG. 11 on level ground with the forks extended as part of a pallet pick up operation with the pallet being nested in the forks and ready for lifting from the ground.

FIG. 16 shows the robotic forklift of FIG. 11 on ground that includes a raised area on which a pallet to be picked up is positioned.

FIG. 17 shows the robotic forklift of FIG. 11 performing the first step of a two bite (e.g., double bite) pickup procedure in which the pallet will be raised, moved, lowered and the forks reinserted to achieve proper pallet nesting before the robotic forklift moves to take the pallet to a new location.

FIG. 18 shows the robotic forklift of FIG. 11 lifting the pallet shown in FIG. 17 as part of the double bite pickup procedure.

FIG. 19 shows the robotic forklift of FIG. 11 retracting the pallet fork to move the pallet while it is in the air so it can be lowered and repositioned as part of the double bite pickup procedure.

FIG. 20 shows the robotic forklift of FIG. 11 after it has lowered the pallet to the ground as part of the double bite pickup procedure.

FIG. 21 shows the forks of the robotic forklift device of FIG. 11 re-inserted into the pallet to achieve full nesting of the pallet as part of the double bite pickup procedure.

FIG. 22 shows the pallet having been lifted following full nesting of the pallet as part of the double bite pickup procedure and now being ready for transport.

FIG. 23 shows the pallet fully nested and being transported by the robotic forklift to a new location away from the raised shelf where the pallet was previously stored.

FIG. 24A is a diagram showing a first part of a flow chart showing a method implemented in accordance with one embodiment of the invention.

FIG. 24B is a diagram showing a second part of a flow chart showing a method implemented in accordance with one embodiment of the invention.

FIG. 24C is a diagram showing a third part of a flow chart showing a method implemented in accordance with one embodiment of the invention.

FIG. 24D is a diagram showing a fourth part of a flow chart showing a method implemented in accordance with one embodiment of the invention.

FIG. 24 is a diagram showing how the diagrams of FIGS. 24A, 24B, 24C and 24D can be combined to form a complete flow chart showing steps of an exemplary embodiment.

FIG. 25 illustrates an exemplary pallet with a payload, i.e., set of boxes, to be moved.

FIG. 26 illustrates the exemplary pallet with payload of FIG. 25 with a 3D shape, corresponding to outer edges of the pallet with the payload, said 3D shape having been determined and being displayed around the perimeter of the pallet and payload.

FIG. 27 illustrates the exemplary pallet with payload of FIGS. 25 and 26 with some of the boxes on the pallet having shifted during the move and now extending beyond and above the right side of the pallet.

FIG. 28 illustrates the exemplary the pallet with payload of FIG. 27 that shifted position during transport with a 3D shape, corresponding to outer edges of the pallet with the payload, said 3D shape having been determined and being displayed around the perimeter of the pallet and payload.

FIG. 29 illustrates a pallet rack with multiple locations in which a pallet with goods can be stored.

FIG. 30 illustrates the pallet rack of FIG. 29 but with the space available in the top two storage locations based on 3D measurements, e.g., stereoscopic camera based measurements or other measurements with the determined available spaced being represented by 3D objects in the form of cuboids shown using dashed lines.

FIG. 31 is an example of an image of the pallet rack of FIG. 29 with a pallet and goods being checked for possible insertion into the top left storage slot with the previously determined cuboid, corresponding to the pallet with goods and the cuboid corresponding to the available space, being superimposed on an image of the pallet with goods and pallet rack to allow an operator to visually understand and check whether the pallet with goods will fit in the available storage space.

FIG. 32 is a diagram showing a visual indication, e.g., color represented in the Figure as a solid black line, around the cuboid corresponding to the pallet with goods with the color indication having been added to the right side to the pallet with goods shown in FIG. 31 to visually indicate a predicted area of collision which is expected to occur if the pallet with goods is inserted into the upper left storage location of the pallet rack.

FIG. 33 shows the pallet with goods, 3D cuboid shape serving as a pallet with goods volume indicator and another cuboid serving as an available space indicator while are all visible as part of a check to make sure the pallet and goods can be successfully placed into the top right storage location of the pallet rack.

FIG. 34 shows the pallet with goods after successful insertion into the top right storage location of the pallet rack.

### DETAILED DESCRIPTION

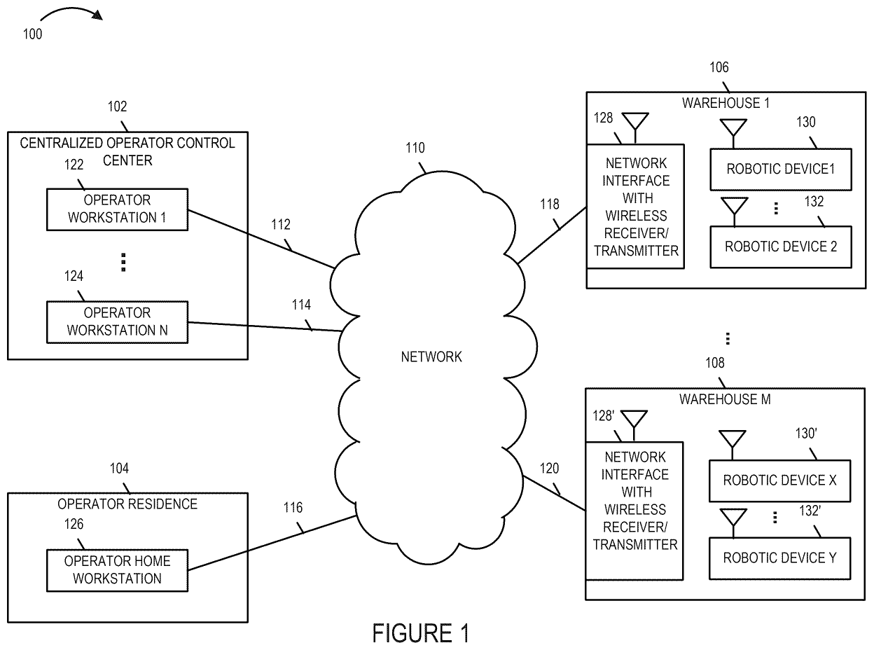

FIG. 1 is a drawing of a system 100 implemented in accordance with one exemplary embodiment. The system 100 includes a centralized operator control center 102, one or more operator residences 104, and a plurality of warehouses 106 through 108 which are coupled together for communications purposes via communications links 112, 114, 116, 118, 120 and a network 110. While two warehouses 106, 108 are shown, the centralized operator control center 102 may provide services to a large number of warehouses some of which may be located miles away or even in different states. The communications network 110 may be, and sometimes is, the Internet.

While the invention is being explained in the context of an example where the devices to be controlled are robotic forklifts located at warehouses, it should be appreciated that the methods and apparatus described herein relating to the remote control of devices which are moveable or have moveable elements such as forks or arms, can be applied to a wide range of devices that can be controlled remotely including different types of vehicles, assembly robots, etc. located in a wide range of different environments. Accordingly, it should be appreciated that the forklift related embodiment is exemplary, and that the invention is not limited to being used solely with forklifts and can be used with a wide variety of controllable devices that can be remotely controlled.

The centralized operator control center 102 is shown located remote to the warehouses 106, 108 but may be located in, or adjacent to, one of the warehouses 106, 108 while being remote to other ones of the warehouses 106, 108. The centralized operator control center 102 includes a plurality of operator workstations 122, 124 which are coupled via corresponding links 112, 114 to the network 110 and thus can communicate with devices 130, 132, 130′, 132′ located at the various warehouses 106, 108 via the network 110.

Operator residence 104 includes an operator home workstation 126 which is the same or similar to the workstations 122, 124 located at the centralized operator control center 102 allowing an operator to work from his/her home and remotely operate robotic or other controllable devices 130, 132, 130′, 132″. Operator home workstation 126 is coupled to network 110, via communications link 116, through which it can communicate with devices to be controlled. While a single exemplary operator residence 104 is shown in FIG. 1, multiple operator residences may be present in the system 100. Human operators are at the workstations 122, 124, 126. As will be discussed below the operator workstations 122, 124, 126 include network interfaces through which the workstations can receive signals, video and other information from robotic devices 130, 132, 130′, 132′ and send control and other signals to the robotic devices 130, 132, 130′, 132′

Each warehouse 106, 108 includes a network interface 128, 128′ which supports a wired and/or fiberoptic connection 118, 120 to network 110 and also supports wireless communications using antennas. The network interfaces 128, 128′ can be, and sometimes are, implemented as WiFi access points or other local wireless communications devices which have a wired and/or wireless interface and which can support communications between the robotic devices 130, 132, 130′, 132′ and network 110.

Robotic devices 130, 132, 130′ and 132′ can be controlled via the remote operator workstations 122, 124, 126 and communicate to the operator workstations 122, 124, 126 via a wireless connection to the network interface 128, 128′ in the warehouse 106, 108 in which the device 130, 132, 130′ 132′ is located and network 110. The latency of the communications connection between an operator workstation 122, 124, 126 and a robotic device 130, 132, 130′ and 132′ will depend on the latency of the individual links which connect the devices and can vary over time, e.g., based on operator workstation location, robotic device location and/or network issues which can affect latency through the network 110. The latency can be measured in a variety of ways, e.g., with a workstation sending a signal and then measuring a time between when the signal is sent and a response to the signal is received. Similarly, a robotic device can measure the latency between the robotic device and an operator workstation controlling it by sending a signal to the workstation and then measuring the time between when the signal was sent and a response was received. The latency in one direction may be, and sometimes is, assumed to be half the round trip latency. Other techniques for measuring latency can also be used.

The amount of bandwidth that can be supported from a robotic device and an operator workstation can depend on wireless conditions at the warehouse at which the device to be controlled is located, network loading and a variety of other issues. Testing of how much bandwidth can be supported can be determined by sending a test load or other known amount of data over the communications path to be tested and the device receiving the data reporting back how much data was received in a test period of time. For example, robotic device 1 130 can communicate test data to operator work station 122 in different known amounts and the operator workstation 122 can report back based on the received test data the amount of data, and thus bandwidth, the data path between the robotic device 130 and operator workstation 122 reliably supports. The latency and bandwidth of a communications path can be tested/measured repeatedly at different points in time and adjustments in control parameters and/or what information, e.g., video data, is communicated modified in response to changes in the latency and/or bandwidth between the robotic device being controlled and the workstation used to control the device.

As will be discussed below, the operator workstations 122, 124, 126 can operate as device simulators with control and other inputs corresponding to the device to be controlled and simulated outputs, e.g., sounds and/or a displayed field of view. For example, the operator workstation 122 may, and sometimes does, include one or more pedals used to control forklift motion and levers/controls used to control lifting or lowering of forklift forks and/or forklift mast tilt controls.

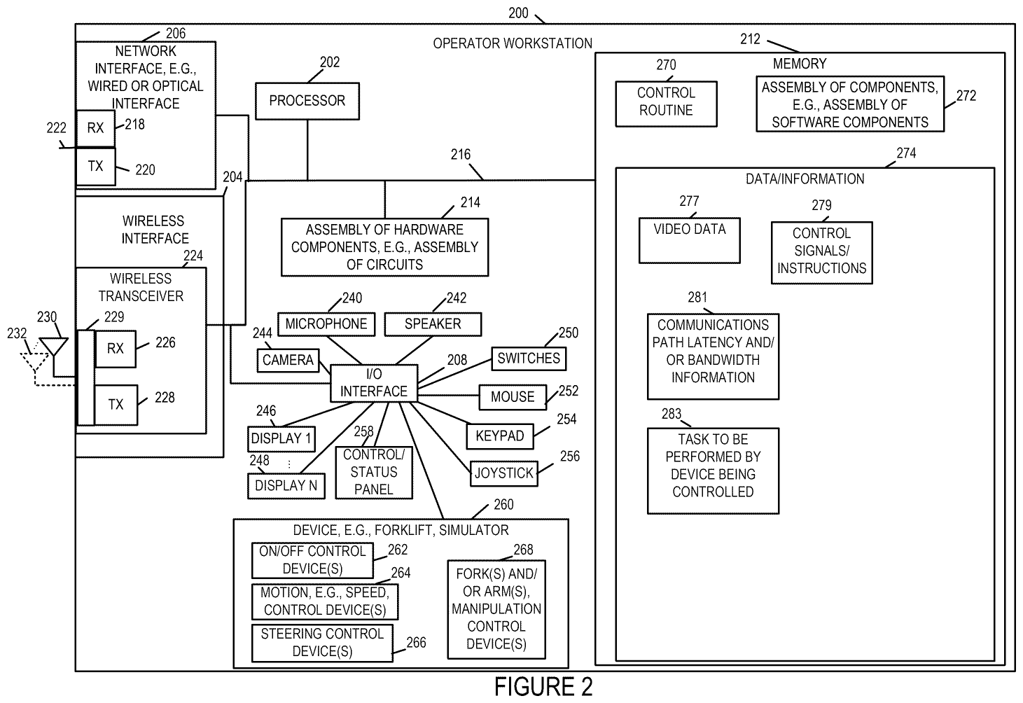

FIG. 2 illustrates an exemplary operator workstation 200 that can be used as any of the operator workstations 122, 124, 126 shown in FIG. 1. The operator workstation 200 includes a first wired or optical network interface 206 in addition to a second wireless interface 204. The first network interface 206 includes a receiver 218 and a transmitter 220 coupled to fiberoptic or wired link 222 which couples to the operator workstation 200 to, e.g., communications network 110. The second wireless interface 204 includes a transceiver 224 that includes a wireless receiver 226 and a wireless transmitter 228 which are coupled to one or more antennas 230, 232 by antenna control network 229. The antenna control network 229 can alter antenna connectivity depending on whether receive, transmit and/or both receive and transmit operations are to be performed and whether beam forming is supported. In cases where beam forming is not supported a single antenna 230 may be used. Thus, an array 230, 232 of antennas is optional and not used in all embodiments.

The first and second network interfaces 206, 204 are coupled to a processor 202, assembly of hardware components 214, memory 212 and I/O interface 208 via bus 216 allowing the components coupled to the bus 216 to exchange information, video data, control signals, etc. The processor 202 controls the operator workstation 200 to implement the methods described herein and to perform the steps described in the present application which are performed by the operator workstation under the direction of the control routine 270 stored in memory. In addition to the control routine 270, the memory 212 includes an assembly of components, e.g., an assembly of software components 272. The software components 272 include processor executable instructions which when executed by the processor 202 cause the processor 202 to implement one or more functions performed as part of the methods described herein. The memory 212 also includes data/information 274 such as received video data 277, e.g., images, of an environment in which a controlled device is working, control signals/instructions 279 obtained from operator input, in addition to communications path latency and/or bandwidth information 281, which indicates the latency and/or bandwidth associated with a device being controlled from the operator workstation 200. The data/information 274 also includes information 283 indicating a task to be performed by the device being controlled by the operator of the operator workstation 200. The task may be indicated by the operator of operator workstation 200 or in many cases may be signaled to the operator workstation 200 by a robotic device when the device initiates an automatic request for operator control or operator assistance when a control device determines that an operation scheduled to be performed is risky and should not be implemented automatically without operator assistance. This is particularly the case with some semi-autonomous devices where a robotic device will perform some low risk operations automatically but automatically connect to an operator workstation when a risky operation such as picking up a pallet of items or working near an edge with a fall off is required. The task information 283 can also be automatically inferred by the processor 202 detecting a known sequence of operations corresponding to a particular task which is determined and then stored in memory 283. For example, a known operator initiated sequence of operations corresponding to approaching and picking up a loaded pallet may result in the operator workstation 200 or device being controlled determining that a loaded pallet pick up task is to be performed.

Various input and/or output devices are coupled to the I/O interface 208. In the FIG. 2 example these input and/or output devices includes a microphone 240, speaker 242, camera 244, switches 250, mouse 252, keypad 254, joystick 256, control status panel 258 and one or more displays 246, 248. While some of these devices such as the displays 246, 248 can be used for device control related operations such as displaying video received from or corresponding to the device being controlled, in some embodiments device operator simulator components are also included to provide the operator an experience similar to what might be encountered if the operator were directly operating the device, e.g., forklift, at the site where the device is located. Device, e.g., forklift, simulator 260 is coupled to the I/O interface to provide device inputs which are the same or similar to those an operator of the device would use to control the device, e.g., forklift, if present at the device. The simulator 260 includes various on/off control switches 262 used for enabling/disabling different device functions, a motion, e.g., speed, control device 264 such as a fuel pedal, one or more steering control devices 266, e.g., a steering wheel, and/or controls 268 for device attachments such as a forklift mast tilt control and/or fork raise/lower control. Input signals generated by the device simulator 260 are automatically converted into electrical signals and/or commands which are supplied to the I/O interface and thus the processor 202 via bus 216. The simulator 260 allows an operator to control the remote device while images of the device environment are displayed on one or more of the displays 246, 248.

As will be discussed below, the maximum speeds permitted at different times and/or the rate at which components of the device being controlled are allowed to move can be, and sometimes are, made a function of communications path latency. For example, the turning of the steering control device may result in a slower response and/or require more rotations in the case of higher latency than when there is low latency. In this way the operator controls automatically reflect to some extent the latency in the communications path. Similarly, the maximum speed in a given direction or the rate at which forks are raised/lowered may be, and sometimes are, scaled or limited based on latency. The slowing of speeds as communications latency increases gives changes in position more time to be captured on camera or detected by another sensor and communicated back to the operator for display. Thus the operator is less likely to make positional control errors due to a miss-understanding of device position even in cases where latency changes. Device speed and/or other control operations may be, and sometimes are, controlled based on the task to be performed and/or environmental conditions in addition to latency. While communications latency is used in some embodiments as a control factor, in some embodiments control parameters are adjusted based on environmental conditions and/or the task to be performed even if latency is not considered.

In some embodiments, the image or image portions of the environment displayed may be, and sometimes are, selected/controlled based on the amount of bandwidth available between the operator workstation 200 and/or the task to be performed.

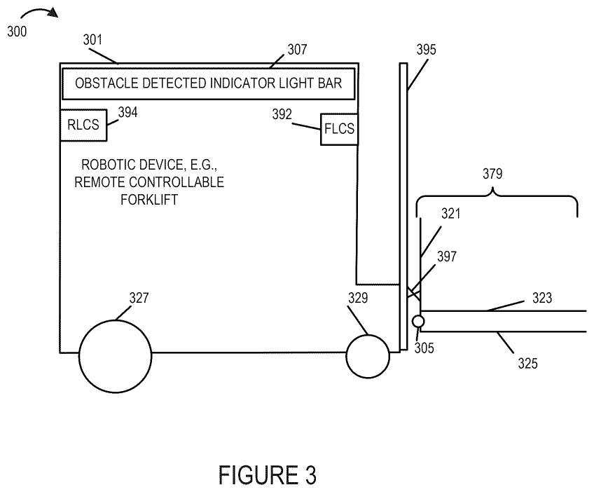

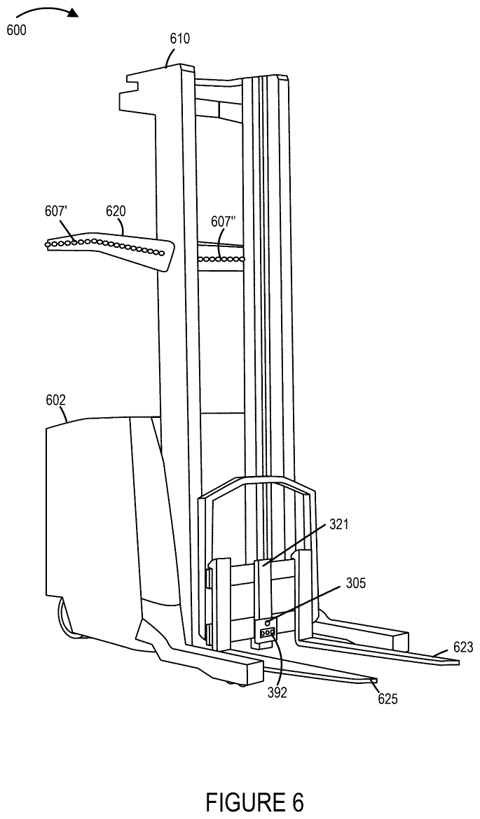

FIG. 3 illustrates an exemplary device 300, e.g., a robotic forklift, which can be remotely controlled in accordance with some embodiments and which can be used in the system of FIG. 1 as any one of the robotic devices 130, 132, 130′, 132′ shown in FIG. 1. The forklift 300 includes a main housing 301 in which a motor and other components are housed or connected to, wheels 327, 329 a mast 395 which in various embodiments can be controlled to tilt and a set of forks 323, 325 and which sometimes serves as a camera array mounting location, e.g., a location on which camera array 392 can be and sometimes is mounted high up. An extendable fork assembly support 397 attached the fork assembly including backrest 321 and forks 323, 325 to the mast allowing the fork assembly to be moved extended and retracted in combination with tilting of the mast 395 as needed. The backrest 321 in some embodiments includes a vertical center member on which a pallet position sensor 305 is mounted and multiple horizontal members on which the forks 623, 625 can hang. The backrest 321 may further include a railing or guard behind the horizontal members which extends up above the horizontal member and reduces the risk of a load falling in the direction of the forklift mast 610 as shown in FIG. 6 for example.

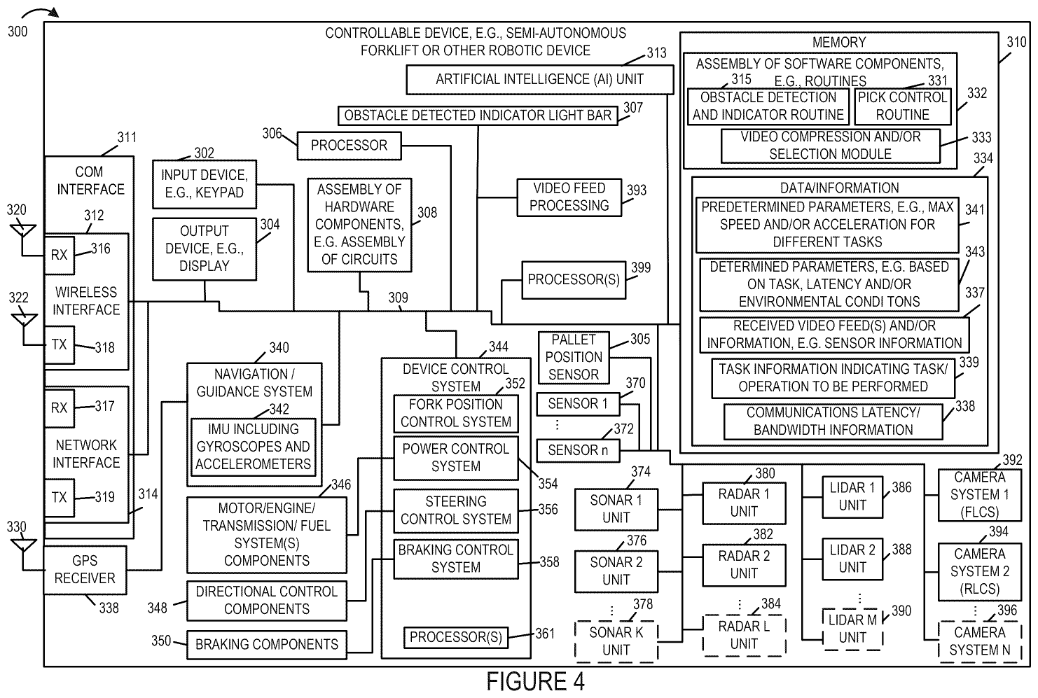

In the FIG. 3 example an obstacle detected indicator light bar 307 which includes a string of independently controllable lights is included along a top portion of the robotic device, e.g., along the top of the main body 301 or a canopy which is used in some embodiments. In some embodiments a light or lights on the light bar 307 closest to a detected obstruction are illuminated to indicate that the obstruction was detected. The lights of the lightbar 307 extend around the robotic device to provide a range of indicators extending 360 degrees around the robotic device. FIG. 3 is simplified diagram and additional examples of obstruction detected indicator light bars are visible in FIGS. 6-10 which show alternative embodiments of the exemplary robotic device shown in FIGS. 3 and 4 and which can include the components of the robotic devices shown in FIGS. 3 and 4 but perhaps in a slightly different arrangement and/or with different placements for various components.

The forks 323, 325 can be raised and lowered. The robotic device 300 includes a variety of cameras and other sensors as will be discussed further with regard to FIG. 4. In the FIG. 3 diagram, a first camera system 392, which is a forward looking camera system (FLCS), which includes a first set of forward looking cameras is shown, and a second camera system 394, which is a rear looking camera system (RLCS), which includes a second set of rear looking cameras is also shown. The FLCS 392 provides images of the forklift area to facilitate an operator controlling a pallet pickup/lowering operation and/or other pallet manipulation as well as controlling forward travel of the forklift 300. In some cases, the FLCS 392 and RLCS 394 are or include sets of cameras which provide images that are used for stereoscopic depth determination and/or obstruction detection with different images of the same scene area being provided by different cameras in the area to facilitate stereoscopic depth and 3D shape determinations. Side facing pairs of cameras and/or other sensors may be, and sometimes are, also included, allowing obstructions to be detected in all directions. The stereoscopic cameras and/or other sensors also support determining the distance to detected obstructions and/or determining the type of detected obstruction, e.g., human or another type of object. The cameras of RLCS 394 are used to provide a view of the area behind the forklift device for backup or other operations. While shown as mounted on the body of the robotic forklift in some cases the cameras of the FLCS 392 or another set of forward looking cameras are positioned on the backrest 321, which is part of the fork assembly which also includes forks 323, 325.

In some cases, a pallet position sensor 305 is also mounted on the backrest 321 of the fork assembly allowing a determination to be made as to when a pallet is nested, e.g., seated against, the backrest 321. The position sensor 305 is able to measure the distance from the sensor 305 to a pallet on the forks 323, 325 and this distance information is used to determine, in some cases, if the pallet is positioned against the backrest 321 to which the position sensor 305 is mounted. To avoid damage to the position sensor 305, the position sensor 305 is sometimes mounted slightly behind the frontmost surface of the backrest 321, which should prevent actual physical contact with the sensor 305 which may be, and sometimes is, an ultrasonic distance sensor or another type of distance sensor which does not require physical contact to measure distance. In other embodiments a contact sensor may be used to determine that the pallet is properly positioned, e.g., at the proper distance from where the main body of the sensor 305 is mounted however such distance position sensors are more likely to be subject to damage from physical contact with a pallet.

In the case where the bandwidth between the forklift 300 and operator workstation 122 used to control the forklift 300 supports the communication of multiple images, multiple views, e.g., RLC and FLC video, will be supplied to the operator workstation 122 to provide a large amount of situational awareness. In cases where the available bandwidth will not support multiple views, one of the camera outputs may be prioritized, while feeds from the other camera outputs are discontinued or transmitted less frequently than from the highest priority camera. In some embodiments foveation is supported with portions of a camera output, images, being processed, e.g., subject to cropping and/or low resolution representation, based on what portion of a scene the operator working at the operator workstation 122 selects to view at a given time. The viewing, e.g., field of view information, is detected using a sensor, e.g., eye tracking sensor, at the workstation 122 and communicated to the device being controlled to facilitate foveation and/or selection of which camera feed or feeds to supply to the operator workstation 122 when bandwidth is limited.

Having generally described the device, e.g., robotic forklift, 300 to be controlled with regard to FIG. 3, it will now be discussed in greater detail with reference to FIG. 4.

FIG. 4 is a block diagram of the exemplary device 300 of FIG. 3 showing various components of the exemplary device 300 in block diagram form and in greater detail than is shown in FIG. 3. The components of the device 300 shown in FIG. 4 are included in the robotic devices shown in the other figures and examples of this application as well in some embodiments and thus FIG. 3 is to be considered exemplary of the components which are included in various robotic device embodiments.

Controllable device 300, e.g., a robotic forklift or another device, includes an input device 302, an output device 304, an obstacle detected indicator light bar 307, a pallet position sensor 305, a processor 306, an assembly of hardware components 308, e.g., an assembly of circuits, memory 310, a communications interface (COM interface) 311, a navigation/guidance system 340, a vehicle control system 344, a plurality of sensors (sensor 1 370, . . . , sensor n 372), a plurality of sonar units (sonar unit 1 374, sonar unit 2 376, . . . , sonar unit K 378), a plurality of radar units (radar unit 1 380, radar unit 2 382, . . . , radar unit L 384), a plurality of LIDAR units (LIDAR unit 1 386, LIDAR unit 2 388, . . . , LIDAR unit M 390), a plurality of cameras systems (camera system 1 392, which is a FLCS including a set of forward looking cameras, camera system 2 394, which is a RLCS including a set of rear looking cameras, . . . , camera system N 396 including another set of cameras), and an artificial intelligence (AI) unit 313 coupled together via bus 309 over which the various elements may interchange data and information. While a combination of sensors, sonar, radar and LIDAR units are shown in the example, the device 300 may include some or none of these sensors/measuring devices depending on the embodiment. The communications interface 311 includes a wireless interface 312 and a network interface 314. The wireless interface 312 includes a receiver circuit 316 and a transmitter circuit 318. The network interface 314 includes a receiver circuit 317 and a transmitter circuit 318. The robotic device 300 can communicate with the operator workstation using either the wireless interface 312 and/or network interface 314. In the case of wireless communications, the communications may occur directly with the operator workstation wirelessly but in many cases wireless signals are communicated between a warehouse network interface 128 such as a WiFi access point and then between the WiFi access point and operator workstation via one or more wired or optical connections.

Input device 302, e.g., a keypad, is used for receiving manual input, e.g., from a service technician, e.g., to alter device settings and/or access information stored on the device, e.g., robotic forklift. The output device(s) 304 e.g., a display and/or status lights or indicators and/or an audio output device, e.g., alarm, siren, speaker, etc., is used for outputting information, warnings, and/or status indications to an operator of the device 300, a device monitoring individual, or a device service person. The processor 306, e.g., a CPU, executes routines, e.g., routines loaded into the processor 306 from memory 310 to control the operation of the robotic device 300. A video compression and/or selection module 333, included in the assembly of software components 332, controls video selection and/or compression and thus in some cases controls what video or images will be returned to the operator workstation controlling the device 300.

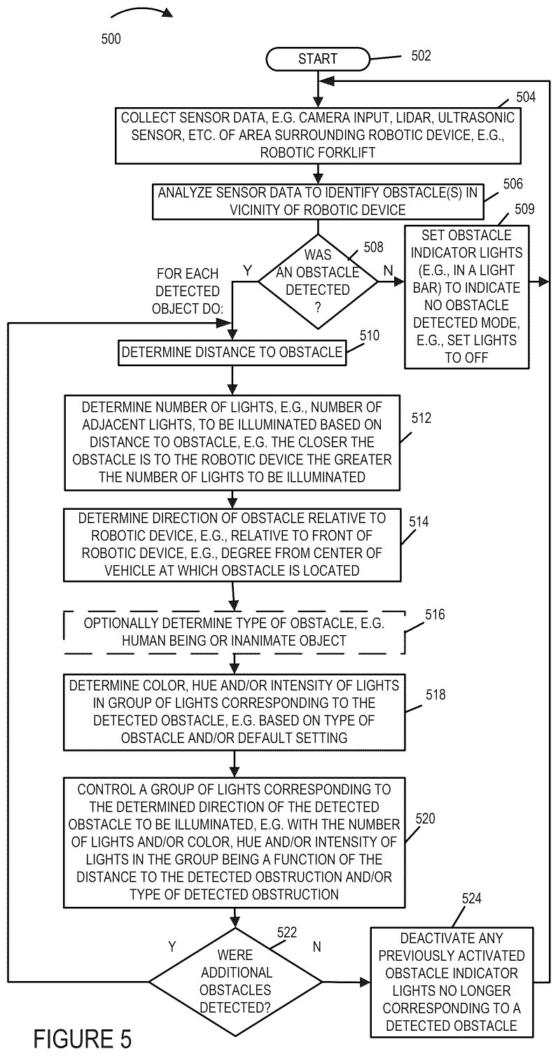

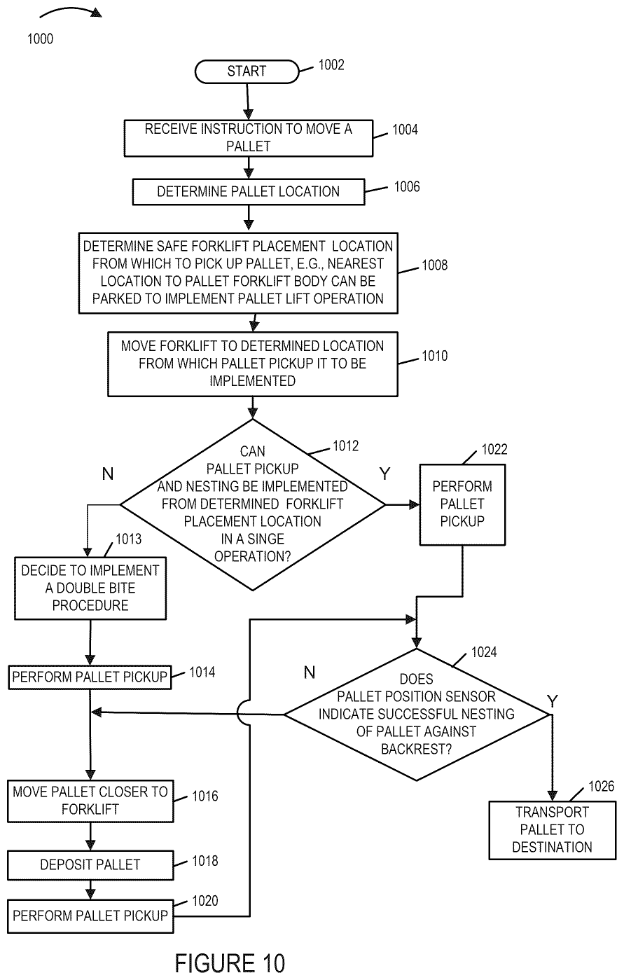

Memory 310 includes assembly of software components 332, e.g., routines, and data/information 334. In some embodiments, a component, e.g., a routine, in the assembly of software components 332, when executed by processor 306, 399, or 361, implements a step of an exemplary method, e.g., the method of flowchart 500 of FIG. 5. The assembly of software components 332 includes the video compression module and/or selection module 333. The assembly of components 332 also includes an obstacle detection and indicator routine or module 315 which detects obstacles, e.g., based on sensor input, determines distance to individual detected obstacles, the type of detected obstacle and/or which light or set of lights on the light bar 307 should be illuminated to indicate that a particular obstacle was detected. FIG. 5 illustrates steps which may be, and sometimes are, implemented by the robotic device 300 under control of processor 399 when obstacle detection and indicator routine 315 is implemented, e.g., during autonomous mode or semi-autonomous mode operation or during other modes of operation, e.g., manned mode of operation where automatic obstacle detection is implemented. Pick control routine and/or component 331 controls pick operations, e.g., pallet pickup operations, based on the distance from the forklift body position to a pallet to be picked up and/or based on the output of pallet position sensor 305. FIG. 10 illustrates steps which can be and sometimes are implemented under control of pick control routine 331 when it is executed by a processor such as processor 399. In some embodiments pick control routine 331 will trigger a double bite pickup operation when a pallet is too far for the forklift to reach and achieve a nesting position from where the forklift can park to perform the pickup. In other cases, an attempt to implement a pallet pickup and achieve nesting in a single pickup operation may fail for a variety of reasons including slight inaccuracy of robotic device placement at the start of the pick operation. In response to the pallet position sensor 305 detected that a pallet has not been positioned in the desired nesting position against the backrest the pick control routine 331 will trigger a place and repick operation which normally results in proper nesting of the pallet before the robotic forklift begins moving to a new location.

Data/information 334 includes information 337 including received video feed(s) and/or information, e.g., sensor information, captured video and/or information, e.g., sensor information, from one or more of the cameras/sensors. The memory 310 includes operating parameter information such as maximum device speed and/or acceleration and/or max speed and/or acceleration of components, e.g., forks, which are part of the robotic device 300. Memory 310 includes a set of predetermined parameters 341, e.g., max speed and/or max acceleration for different tasks which may be, and sometimes are, performed by the robotic device. For example, the predetermined parameters 341 may specify a first maximum speed for the robotic device 300 moving between locations with items on its forks and a second lower maximum speed for the robotic device 300 moving with one or more items on its forks.

In addition, the parameters may include a maximum acceleration for one, more or all tasks for which a maximum speed is indicated. Thus, in some embodiments the predetermined parameters include pairs of maximum permitted speed and maximum permitted acceleration for multiple tasks which can be performed. Tasks for which maximum speed and acceleration are specified can include tasks relating to movement of a device component such as forks of the robotic device 300. In one embodiment the predetermined parameters include a first predetermined maximum fork raising and/or lowering speed, and corresponding maximum fork acceleration, for the task of raising or lowering the forks when the forks are empty and a second lower predetermined fork raising and/or lowering speed, and corresponding second maximum fork acceleration, for the task of raising or lowering the forks when the forks are loaded, e.g., with a pallet or other item(s). The predetermined parameters may be, and sometimes are, maximum speeds/accelerations which can be safely supported for various tasks likely to be performed by the robotic device 300, e.g., under operator control, in the absence of communications latency problems or environmental hazards such as the presence of people or drop offs such as stairs, pot holes or the edge of a loading dock off of which the robotic device 300 might fall.

Determined parameters 343 are operating parameters, e.g., determined by processor 306, that the robotic device should use to perform a determined task based on communications latency and/or environmental conditions present at the time the task is to be performed under control of a remote operator workstation 122. The determined parameters 343 include maximum device speed and acceleration and/or maximum speed of a device component, e.g., forks and/or corresponding maximum acceleration. The determined parameters 343 will in many cases be lower than the predetermined parameters for the task to be performed because they may and often will have been modified, e.g., lowered, based on communications latency between the robotic device 300 and operator workstation controlling the device and/or because of the presence of one or more environmental hazards such as the presence of a drop off or a human in the robotic device's operating area, e.g., the environment in which the robotic device is to perform the task for which the control parameters 343 are determined.

The memory 310 also includes information 338 on a determined communications latency and/or bandwidth between the controllable device 300 and the operator workstation 122 being used to control the device 300 and task information 339 indicating a task to be performed by the device 300. The task to be performed, may be determined based on stored instructions or e.g., by the artificial intelligence unit 313 based on a sequence of operations initiated by a remote operator.

Wireless interface 312 includes a wireless receiver 316 coupled to receive antenna 320 via which the device to be controlled, e.g., forklift 300, receives control signals, commands from the operator workstation. The wireless interface 312 also includes a wireless transmitter 318 coupled to transmit antenna 322 via which the device 300 transmits wireless signals, e.g., sensed information and/or video, along with task information in some cases. In some embodiments, there is a wireless link between the wireless interface 212 and a network interface 128 or 128′. The network interface, e.g., network interface 128 is responsible for acting as an intermediary and for communicating signals sent using network 110 to/from the controllable device 300. Network interface 314 includes a receiver 317 and a transmitter 319, via which the device 300 can communicate with test equipment and/or which is used to configure the device 300, e.g., when the device is parked, e.g., at a depot, garage, and/or service, repair and/or maintenance facility into which a wired or fiber connection can be made with the network interface 314.

Controllable device 300 further includes an embedded GPS receiver 338 coupled to GPS antenna 330, which receives GPS signals and determines time information, a position fix, e.g., latitude/longitude/altitude, and/or velocity information for the device 300. The output of GPS receiver 338 is fed as input to navigation/guidance system 340. Navigation/guidance system 340 includes an inertial measurement unit (IMU) 342, e.g., an IMU on a chip, including gyroscopes and accelerometers. Navigation/guidance system 340, provides filtered location, attitude, acceleration and/or velocity information, and is used to route the device 300, e.g., a forklift, along an intended path. While GPS is used when GPS signals are available, in indoor situations the device 300 may operate without GPS signals/information.

Device control system 344 includes a fork position control system 352, a power control system 354, a steering control system 356, a braking control system 358, and processor(s) 361. Power control systems 354 is coupled to motor/engine/transmission/fuel system(s) 346, included in device 300, e.g., a forklift 300, and is used to control motion of the device 300, e.g., forklift 300, e.g., forward, reverse, speed, acceleration, deceleration, etc., motion of the forks 323, 325 and/or fork mast 395 which in some embodiments can be tilted. Steering control system 356 is coupled to directional control components 348, e.g., steering motors, steering linkages, rack and pinion, gear box, etc., and is used to control the direction of device 300, e.g., forklift 300. Braking control system 358 is coupled to braking components 350, e.g., brake actuators, brake cables, wheel speed sensors, wheel motors, ABS system components, etc., included in device 300, e.g., forklift 300, and is used to control braking of the device, e.g., forklift 300.

Sensors (370, . . . , 372) include, e.g. speed sensors, motion sensors, proximity sensors, etc., and collect information used to control device 300, e.g., forklift 300. Sonar units (374, 376, . . . , 378) are used to perform distance measurements to other objects in the vicinity of the device 300, e.g., forklift 300. Radar units (380, 382, . . . , 390) are used to detect and measure the speed of other objects in the vicinity of the device 300, e.g., forklift 300. Light detection and ranging (LIDAR) units (386, 388, 390) use lasers or other light to detect and range objects in the vicinity of the device 300, e.g., forklift 300. Cameras included in the camera systems (392, 394, . . . 396), are mounted and oriented on the device 300 to capture different fields of view, capture images, e.g., video feeds, which are streamed, e.g., selectively streamed, to the operator control station 122, and/or are used to provide assistance in automatically moving or re-positioning the device 300, e.g., forklift 300, e.g., when performing some tasks in a full automated manner.

Video feed processing 393 receives video feeds from cameras on the device 300, e.g., forklift 300, and provides selection, compression, cropping and/or foveation on captured images, e.g., images of the environment and/or scene area in which the device, e.g., forklift is being used, prior to the images being communicated to the remote operator. Processing performed by video feed processing unit 393 can be, and sometimes is, based on information about the scene area an operator is looking at which is detected at the operator workstation 122 and communicated to the controllable device, e.g., forklift 300, in some embodiments.

FIG. 5 is a flow chart 500 illustrating the steps used in one exemplary embodiment to provide a visual indication of one or more detected obstructions which may be, and sometime are, objects or human beings in the area of a robotic device, e.g., an autonomous, semi-autonomous, or remotely controlled material handling vehicle such as the robotic device 300. The method starts in step 502 with the robotic device and the processor in the robotic device being powered on. Operation proceeds from start step 502 to step 504, in which sensor data is collected. This can, and sometimes does, involve receiving images from cameras, output of one or more Lidar sensors, the output of one or more ultrasonic sensors, or other types of sensors which are used to sense objects, e.g., obstructions, in the area of the robotic device. The sensor data collected in step 504 is processed in step 506 to identify obstacles in the vicinity of the robotic device. Individual obstacles may be, and sometimes are, detected in step 506. Obstacles detected in step 506 may be, and sometimes are, objects such as boxes, racks, curbs and/or human workers in the area of the robotic device.

In step 508 a check is made to determine if any obstacles were detected in step 506. If no obstacles were detected, operation proceeds to step 509. In step 509 obstacle indicator lights on the robotic device are set to indicate that no obstacle has been detected, e.g., the lights on the obstacle indicator light bar are turned off or set to a color that indicates no obstacles have been detected. Operation process from step 509 back to sensor step 504, which is repeated on an ongoing basis so that changes in the environment and/or changes in vehicle position can be taken into consideration and obstacle light bar indicator output updated accordingly.

Referring once again to step 508 if in step 508 one or more obstacles were determined to have been detected, operation proceeds to step 510. Steps 510 to step 520 will be performed for each detected obstacle.

In step 510 the distance, e.g., from the closest side of the robotic device to the detected obstacle, is determined. Then in step 512 the number of lights to be illuminated is determined based on the distance. For example, in some embodiments the closer the obstacle is to the robotic device, the greater the number of lights facing in the direction of the object that will be illuminated. Thus, the number of lights in some cases is inversely related to, e.g., inversely proportion to, the distance to the detected obstruction, with the shorter the distance the greater the number of lights to be illuminated. In some embodiments the determined number of lights is a group of physically adjacent lights which are determined to correspond to the detected object for purposes of signaling detection of the obstruction.

Operation proceeds from step 512, in which the number of lights to be illuminated is determined based on distance, to step 514, in which the orientation, e.g., direction, of the detected obstruction (obstacle) relative to the robotic device, e.g. relative to the front of the robotic device, is determined. This information is used to determine which lights correspond to the direction of the detected object (obstacle) and thus which lights should be illuminated to signal the direction of the obstruction (obstacle).

Operation proceeds from step 514 directly to step 518 in cases where optional step 516 is not performed or via step 516 in case where this obstacle type determination step is performed. In step 516 a determination is made as to the type of obstacle that was detected, e.g., an inanimate object or a human being. Various known object recognition routines can be used to implement this step which is used in determining what color light to activate in cases where the type of object that was detected is to be visually signaled in addition to the fact that the obstruction was detected.

In step 518 the color, hue and/or intensity of lights in a group of lights is determined to correspond to the detected obstacle for signaling purposes, e.g., based on the number and direction information determined in steps 512 and 514, based on the obstacle type determined in optional step 516, if performed, and/or based on default setting information, is determined. The lighting determination made in step 518 allows the group of lights to effectively point in the direction of the detected obstruction, e.g., by having the center light of the group of lights to serve as a pointer and be the brightest or be of a particular color and also, in some embodiments, to signal the type of object which was detected.

Operation proceeds from step 518 to step 520 in which the group of lights determined to correspond to the detected obstruction (obstacle) are illuminated based on the color, hue and/or intensity determination made in step 518, e.g., with different lights in the group of lights having different colors, hues and/or intensity as appropriate to communicate the determined information (e.g., including direction of obstacle and/or type of obstacle) with the number of lights illuminated being used to indicate the distance to the detected obstruction (obstacle).

With a group of lights corresponding to a detected obstruction (obstacle) having been activated in step 520, e.g., to provide illumination signaling detection of the obstruction, operation proceeds to step 522. In step 522 a check is made to determine if additional obstacles were detected, e.g., requiring the illumination of more lights. In step 522 if it is determined that additional obstacles were detected, operation proceeds back to step 510 so that steps 510 through 520 can be performed for each obstacle detected in step 506.

If in step 522 it is determined that no additional obstacles were detected, e.g., that steps 510 through 520 were performed for each detected obstacle, operation proceeds to step 524. In step 524 previously activated obstacle indicator lights which no longer correspond to a detected obstacle are deactivated. In this way when a previously detected obstacle is no longer detected, e.g., because the robotic device has moved away or the obstacle, e.g., human being, which was previously detected has moved away, the lights used to signal detection of the obstacle which is no longer present will be deactivated if they are not part of a group used to signal the detection of some other obstacle.

Operation proceeds from step 524 to step 504, indicating that obstacle detection and visual indicating of detected obstacles will be performed on an ongoing basis. As a result, the output of the obstruction detection indicator lights will change over time as the environment in which the robotic device changes and/or the robotic device moves in the environment resulting in changes in which obstructions are detected and/or their position relative to the robotic device.

As should be appreciated from the description of FIG. 5, a light array 307, e.g., string or bar of lights, used as obstacle detection indicators, are arranged on one or more sides of a robotic device, e.g., in a row at one or more locations on the body of the robotic device. The robotic device may be, and sometimes is, an autonomous, semi-autonomous, or remotely controlled material handling vehicle, e.g., a robotic forklift or semi-autonomous forklift which can be remotely controlled under some circumstances. Lighting signals are used to indicate the detection of specific obstacles seen by the robotic device implementing the invention.

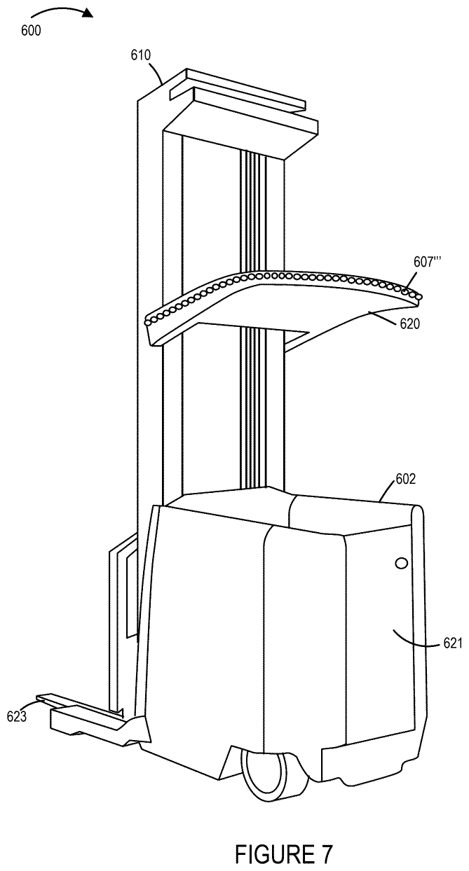

FIGS. 6-8 show exemplary robotic forklifts 600, 800 that are used in some embodiments with the forklifts being shown from different perspectives in different figures. In FIG. 6, the robotic forklift 600 including a main body 602, mast 610, canopy 620, fork backrest 321 and forks 623, 625. Forward looking camera system 392 and pallet position sensor 305 are clearly visible in FIG. 6 and are mounted to the center support of backrest 321. The forklift 602 may include the same components as the robotic device of FIG. 4 but with the combination of lights 607′, 607″, 607″′ (see FIG. 7) serving as the light bar 307 of the FIG. 4 example. Note that in the FIG. 6 example the obstacle detected indicator light bar 607, which includes light strings 607′. 607″, 607″′ are mounted on the canopy 620 so that they are clearly visible to people in the area of the robotic device 600. In FIG. 7 the rear of the robotic device 600 can be seen with the lights 607″′ on the canopy 620 being clearly visible. Thus, the lights 607 are present on all sides of the robotic device and can be used to signal detection of an obstruction in any direction by illuminating a light on the light bar 607 corresponding to the direction of the detected object relative to the robotic device 600. Door 621 allows a human to access the main body 602 of the robotic device for control and/or component access purposes.

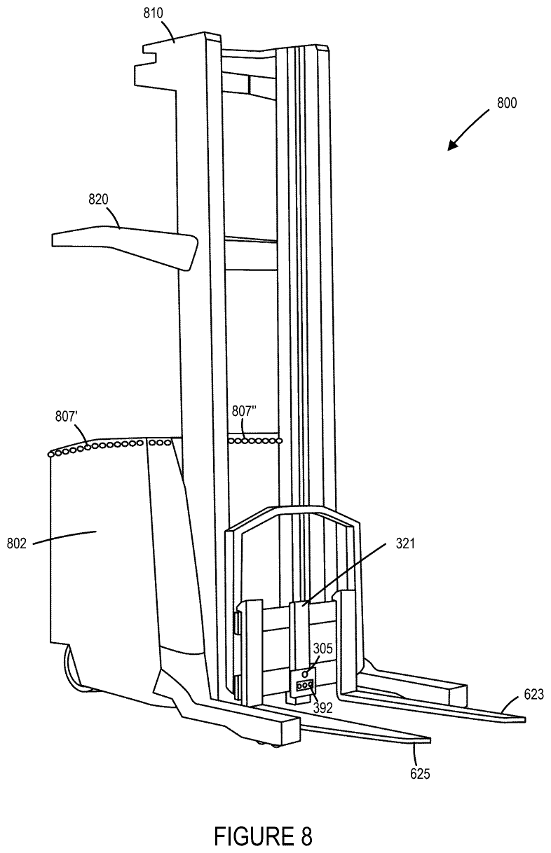

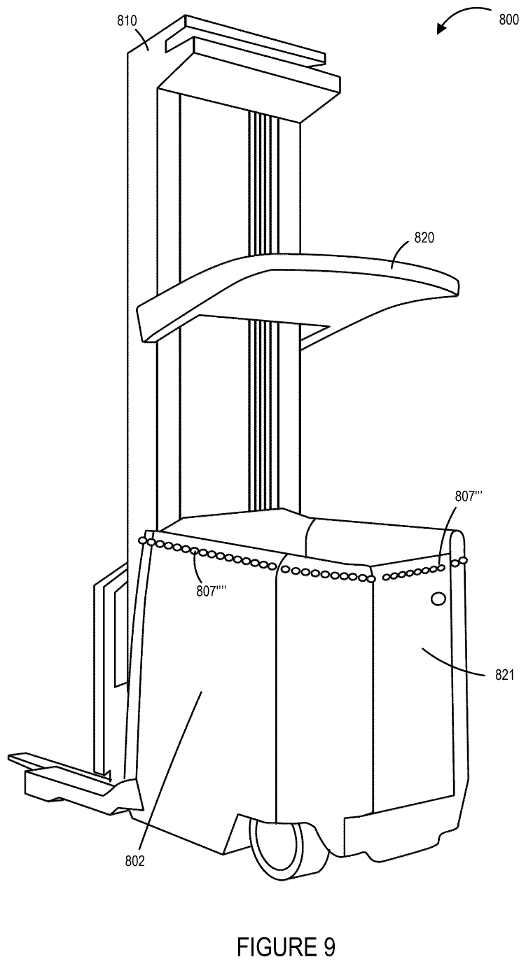

FIG. 8 illustrates another exemplary robotic device 800 with a light bar 807 including light strings 807′, 807″ and 807″′ (see FIGS. 9) and 807″″ (see FIG. 9) being used as the obstacle detection light bar identified in FIG. 4 as reference number 307. Note that in the FIGS. 8 and 9 example the lights of the obstruction detected indicator light bar are positioned on the main body 802 and door 821 leaving the canopy 820 light free or available for other lights, e.g., a siren type light and/or lights used to signal autonomous vs remote controlled operation. Note that in FIG. 9 the lights extend across the top of the rear door 821 since the body 802 is interrupted by the door 821 at this location.

The lighting implementation used in various embodiments such as the ones shown in FIGS. 6-9 provides a feedback mechanism for those observing the vehicle 600 or 800, e.g., human workers in the area of the vehicle or human observers remotely monitoring the vehicle by the use of one or more cameras, to be made aware of the obstacle detection status of the robotic device.

Light is emitted from the robotic device 600 or 800, e.g., via lights in the light bar 607 or 807 facing the direction of a detected obstacle to signal that the obstacle has been detected and the determined distance to the detected obstacle. In this way the obstacle detector indicator light bar 607 or 807 provides an observer a visible indicator that the system is aware of the presence of the detected obstacle when other methods would not be practical or appropriate to notify the observer that the obstacle has been detected. In at least some cases the obstacle is a human worker in the area of the robotic device 600 or 800.

In some embodiments the type of obstacle which is detected is

determined, e.g., using known object recognition algorithms, and the light is controlled as a function of the type of detected object, e.g., a different color can be used to signal detection of a human than an inanimate object.

The indication of a detected object through the use of one or more lights facing in the direction of the detected obstacle, e.g., object, provides a visual signal that can be easily perceived by a human in the area of the robotic device in a similar way that visual signs from a human operator can signal that a human operator is aware of the person working in the area. Thus, the invention mimics the use of visual indication of obstacle detection by a human vehicle operator, through the use of directional lighting highlighting which obstacles are in view, where they are being observed, and how far away they are from the vehicle without the need for a human operator to be involved in the signaling of such information.

While visual indicators of obstacle detection can be useful to signal detection of an obstacle, the lack of a visible obstacle indication, when an observer can see an obstacle in the area of the robotic device, allows the observer to determine that the robotic device's obstacle detection system has failed or may not be working properly. Thus, the methods are not only useful in signaling obstacle detection but can also be useful in identifying or detecting problems with the obstacle detection system.

In some embodiments a light bar (e.g., an LED light bar) 307, 607 or 807 is used as an obstacle indicator device. The light bar in some embodiments is affixed to the robotic device 600 or 800, e.g., autonomous vehicle, in a position with a clear view to observers operating around the vehicle. For example, in the case of a reach truck or other forklift device the light bar may be, and sometimes is, placed around a top cab guard and/or an enclosure providing 360 degree visibility to those around the vehicle. The light bar 307, 607 or 807 in some embodiments is integrated into the vehicle's obstacle detection functionally and/or human detection system, e.g., routine 500 and the corresponding components, in such a way that directionality in relation to the vehicle position can be displayed in the light bar 307, 607, 807 when an obstacle, which in some cases could be a human, is detected.

In some embodiments as the robotic device/vehicle position and/or obstacle position change relative to each other, the lights, e.g. the LEDs, on the light bar 307, 607 or 807 track and display the relative position between the vehicle and the obstacle in real time. The lights can, and in some embodiments do, signal both distance and bearing to a detected obstacle. Distance to an obstacle can be, and sometimes is, indicated by the number of lights illuminated as a set, e.g., with the nearer a detected obstacle is to the device the greater the number of adjacent LEDs in the direction of the obstacle which are illuminated. Direction of the obstacle can be, and sometimes is, indicated by the center of the illuminated lights, e.g. LEDs, corresponding to an obstacle being in the direction of the obstacle. The intensity, color or hue can be, and sometimes is, used to create a perceived arrow or direction indicator pointing in the direction of the detected obstacle, e.g., with the center of the arrow being made brighter than the outer lights of the group of lights being used to point in the direction of the obstacle. In some embodiments a color is used to indicate the type of obstacle that was detected, e.g., with orange being used to indicate a human and red or another color being used to indicate other objects. The particular colors used to indicate different types of objects can vary depending on the implementation.

Thus, in various embodiments the lights, e.g., LEDs, of the lights bars, represented as small circles in FIGS. 6-9, that are illuminated to indicate detection of an object, effectively point in the direction of the obstruction communicating detection of the obstruction and acknowledging the obstructions presence. When an obstacle is no longer detected, the lighting indicator corresponding to the previously detected object will no longer show on the light bar (e.g., the LED light bar), e.g., the lights corresponding to the object will be turned off, indicating that the obstacle which was previously detected is no longer detected by, e.g., is no longer visible to the robotic device.

The number of sides of the robotic forklift on which lights are placed can be as few as one. However, to provide visibility of lights serving as obstacle detection indicators from multiple directions the light string is normally placed on multiple sides of the robotic device 300 and in some cases on all four sides of the robotic device 300. In some embodiments the lights are placed high up, e.g., along the edge of a canopy or roof to increase visibility. The obstacle detection indicator lights may be in addition to one or more lights used for other purposes, e.g., to indicate whether the robotic device is operating in a robotic mode of operation or a remotely controlled mode of operation.

While the obstacle indicator lights are placed high up, e.g., around a canopy or roof in some embodiments, in other embodiments they may be located lower down on the body of the vehicle, e.g., mid-door height or along a middle section of the robotic device.

In some embodiments the lights extend around the upper portion of the forklift body forming what might be thought of as a halo or crown of lights. Sensors, e.g., cameras of camera arrays 394, 392 or a processor processing the images of a camera array or another sensor, detect obstructions, e.g., human workers, near the forklift. Lights surrounding the robotic device nearest to the obstruction are identified based on the direction of the obstruction, e.g., relative to the front of the robotic device. The number of lights to be illuminated based on an individual detected obstruction, e.g., sometimes referred to as an obstacle, is in some embodiments, a function of the proximity of the obstacle to the robotic device. In some embodiments the closer the obstacle to the robotic device the greater the number of lights which will be illuminated. The number of lights to be illuminated due to the detection of an individual obstacle can be, and sometimes are, treated as a group of lights corresponding to the obstacle. The light or LED at the center of the group closest to the obstacle can be indicated using a higher intensity, a particular predetermined color or hue. By controlling the intensity, hue and/or color of lights in a group corresponding to a detected obstacle, is possible to give a human viewer the impression that the lights can, and sometimes do, point to the detected obstacle.

As discussed above with regard to various figures including FIGS. 3, 6 and 9, in some embodiments the robotic forklift 300, 600 or 800 includes, a camera system 392 which includes or is a camera array, in addition to a pallet position sensor 305. In some embodiments such as the ones shown in FIGS. 6 and 8 the pallet position sensor is mounted at a fixed location on the backrest so that the distance it measures is fixed relative to the rear of the forks allowing for the measured distance to be used to determine if the pallet is fully nested. The position sensor 305 in some embodiments outputs a predetermined signal indicating successful pallet nesting when a pallet is successfully inserted on the forks and rests against the backrest and a signal indicating that a pallet is not fully nested at other times. The position sensor 305 is positioned above the camera array 392 on the front of the vehicle on the backrest of the fork assembly in at least some embodiments such as the ones shown in FIGS. 8 and 9. The cameras of the camera array 392 can see the forward facing area and thus provide a view the fork area. The cameras of the camera array 392 can capture images of a pallet in front of the forklift while the position/distance sensor 305 measures the distances between the sensor 305 and an object on the forks, e.g., a pallet. The camera array 392 can be and sometimes is positioned high up on the mast of the robotic forklift or an additional stereoscopic array in addition to camera array 392 is includes so that the location of the front edge of the pallet can be determined from captured images and/or images of a pallet storage area can be captured while a pallet is loaded on the forks. This allows a 3D shape of the pallet with goods on it as well as a 3D shape of a pallet rack where the pallet is to be placed to be generated from captured images even when a pallet is loaded on the forks.

The output of the sensor 305 indicates whether or not successful pallet nesting has been achieved. A processor, e.g., processor 399, used to control forklift operation can determine if a pallet is nested, e.g., fully inserted in the forks, e.g., not fully on the forks as is the case when sensor 305 measures a gap between the rear of the forks and the pallet.

In various embodiments, if the output of the sensor 305 indicates a lifted pallet is not fully nested a double bite procedure is implemented with the pallet be moved closer to the forklift, deposited on the ground and then lifted in an attempt to properly nest the pallet prior to transport.

FIG. 10 is a flow chart showing the steps of an exemplary method 1000 for controlling a robotic device to perform a pick operation, e.g., a pallet pick up operation. The method 1000 can be, and sometimes is, used to control robotic device operation, e.g., operation of a robotic forklift 300, 600 or 800, based on the output of pallet position sensor 305.

The exemplary method 1000 begins in start step 1002, e.g., with a control device such as a processor, e.g., processor 399 or a processor of a workstation, being powered on so that it can be used to perform robotic device control operations. Operation proceeds from start step 1002 to instruction processing step 1004, in which an instruction to move an object, e.g., a pallet with goods, is received. In response to receiving the instruction to move a pallet, operation proceeds to step 1006, in which the location of the pallet is determined, so that a determination can be made as to where the robotic device should be positioned, e.g., parked, to perform the pallet pickup, lift, operation before the pallet is moved to a new location.

With the location of the pallet, to be picked and moved having been determined in step 1006, operation proceeds to step 1008, in which a safe location to position the forklift device, e.g., a location where the forklift device can be parked and held stationary for the pickup operation, is determined. With pallet location and forklift location, e.g., parking position, for the pickup having been determined, operation proceeds to step 1010 in which the forklift is moved to the location from which the pallet pickup, also referred to as a lift, operation is to be implemented.

In some embodiments operation proceeds from robotic device placement step 1010 directly to pallet pickup step 1022 while in other cases a check is made in step 1012 as to whether a double bite pick up is required due to the location of the pallet before a pickup operation is implemented. For example, in some cases the pallet may be recessed and picked up but proper nesting of the pallet on the forks can not be achieved in a single pickup operation due to how far away the pallet is from where the robotic device, e.g., forklift is parked. Movement of the robotic forklift closer to the pallet may not be possible due to a step or obstruction but the forks in such a case might still be able to be used to move the pallet closer to the forklift 300, 600, 800 so that a second pickup operation can be used to achieve proper nesting of the pallet on the forks prior to transport to the target location.

In embodiments in which optional step 1012 is implemented, operation proceeds from step 1010 to step 1012. In step 1012 a check is made as to whether the pallet pickup and proper nesting against the forklift backrest 321 can be achieved in a single operation. This determination is based on whether extension of the forks 323, 325 can achieve the desired nesting or that the forks can be inserted into the pallet to move it but can not be extended far enough to achieve full nesting in a single extension operation. If it is determined that full nesting can not be achieved with a single pickup operation, a decision is made in step 1013 to implement a double bite procedure. If in step 1012 it is determined that full nesting of the pallet can be achieved from the forklift location using a single bite pickup procedure operation proceeds to step 1022 from step 1012.

From double bit decision step 1013 operation proceeds to step 1014, in which the robotic device performs a pallet pickup operation. This, pickup step 1014, is the first step of a double bit pickup operation in which the double bite pickup is being implemented because of the decision in step 1013 to implement such an operation, e.g., due to pallet location.

Operation proceeds from pickup step 1014 to step 1016. Returning once again to step 1012, if a decision is made that the pickup operation can be implemented in a single pickup which should be able to achieve full nesting of the pallet on the forks, operation proceeds to step 1022, in which a pallet pickup operation is performed. In accordance with one feature which is used in some embodiments, a pallet position sensor 305 is used, in step 1024, to determine if, as a result of the pickup operation performed in step 1022, successful nesting of the pallet against the backrest 321 was achieved. Successful nesting is important because successful nesting decreases the chance that the pallet will slip off the forks or shift as the robotic device 300, 600 or 800 moves from the pickup location to the target location where the pallet is to be placed.

If in step 1024 it is determined that the pallet position sensor 305 determined that full nesting was achieved, operation proceeds to step 1026, in which the pallet is transported to the destination location, e.g., by the robotic device driving to the location with the pallet nested on its forks and in the air.

Unfortunately, due to imprecise positioning of the robotic forklift 300, 600 or 800, pallet nesting may not be achieved in some cases by the initial pallet pickup. In such a case the process will proceed from step 1024 to step 1016 to complete the pickup using a double pick operation with the initial pickup 1022 serving as the first pickup of the double pick procedure.

In step 1016, the pallet which was picked up in step 1022 or step 1014, but which did not end up fully against the forklift backrest 321, i.e., did not achieve full nesting, is moved closer to the forklift, e.g., by retracting the forks while the pallet is in the air on the forks. Operation proceeds from step 1016 to step 1018, in which the pallet is deposited on the ground or rack from which it was picked but this time at a position closer to the robotic device 300, 600, 800 than during the initial pick operation. This repositioning of the pallet closer to the forklift for the second pick operation performed as part of the double pick procedure increases the chance that full nesting will be achieved during the second pick operation. Operation proceeds from step 1018 to step 1020, in which the pallet is picked up again. Pickup 1020 is a second or subsequent pickup operation which gives rise to the phase “double pick” operation.

Operation proceeds from step 1020 to step 1024 in which successful nesting of the pallet against the backrest is once again checked by sensor 305. If successful nesting was not achieved, operation proceeds once again to step 1016 so that another attempt and moving and repicking the pallet can be implemented in an attempt to achieve full nesting. However, if as expected the pickup operation in step 1020 achieves full nesting of the pallet against the backrest 321, operation will proceed to transport step 1026 with the pallet being moved to the intended destination.

By using the output of a pallet position sensor 305 to confirm proper nesting of a pallet prior to the robotic forklift 300, 600 or 800 moving to a new location with the pallet in the air, safety is enhanced as compared to systems where proper pallet nesting against the fork assembly backrest 321 is not checked before the forklift moves the pallet.

From the above discussion it should be appreciated that the robotic forklift device 300, 600 or 800 can be automatically maneuvered to a pickup location (P). Normally the pickup location P is sufficiently close to the pallet that a pallet pickup can be implemented by extending the forks into the pallet until nesting is achieved and then lifting the pallet into the air after which the forklift may move to a new position. As discussed above, the output of the pallet position sensor 305, which is used in some embodiments, confirms and/or determines if nesting has been achieved prior to the forklift moving from the pickup location P.

While in many cases the forklift is positioned so that the pallet can be nested using a single fork extension operation, in some cases due to forklift miss-positioning, e.g., due to position sensor inaccuracy, nesting might not be achieved. In the case where a pallet is not nested, it rests on a portion of the fork with a gap between the pallet and back of the fork backrest 321. The further the pallet is out from the rear of the forks/fork backrest 321, the further away the center of gravity is from the main body of the forklift 300, 600 or 800. This can increase the chance of tipping or other issues. In addition, when not fully nested the pallet is more likely to slide since the area of contact, and thus the amount of friction between the forks and the pallet will often be less than what is achieved when the pallet is fully nested. Accordingly for safety reasons pallet nesting can be important.

The addition of the distance sensor 305 to the front of the forklift 300, 600 or 800 which can sense the position of a pallet relative to the rear of the forks and/or fork backrest 321 allows for determining if nesting has been achieved.

If nesting has not been achieved a double bite procedure is implemented as discussed above. In a double bite procedure, the pallet is raised and moved in the direction of the forklift 300, 600, 800, e.g., by retracting the extendable forks. The pallet is then lowered to the ground and the forks are once again extended until nesting is achieved. Once nesting is achieved the pallet is raised and the forklift moves to the intended destination.

A double bite procedure is also useful when, because of an obstruction such as a raised curb, pallet rack support or overhang, the forklift can not be positioned close enough to achieve pallet nesting in a single fork extension operation. In such a case, the forklift can be positioned as close to the pallet as reasonably possible. A lift operation is implemented with the pallet not being fully nested, and the pallet is moved closer to the fork mast by retracting the extended forks. The pallet is then placed on the ground, and the forks are once again extended, with nesting being confirmed before the forklift is moved from the pick location.

The use of the position sensor 305 allows for reliable confirmation of nesting of the pallet regardless of whether a normal or double bite pick operation is implemented. By using the output of the sensor 305 to confirm nesting and to trigger a double bite procedure when nesting is not achieved with a single fork placement, e.g., extension operation, safety and reliability is enhanced as compared to systems which do not include a distance sensor capable of sensing the pallet position at the front of the forklift assembly.

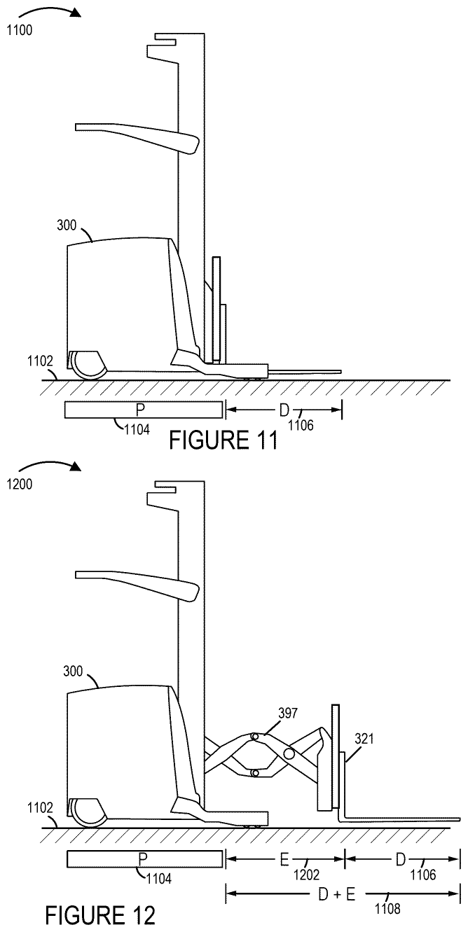

The implementation of a single or double pick operation will be explained now in further detail with reference to FIGS. 11-23 which show the exemplary robotic material handling device 300 in various positions and being used to perform various operations. Reference numbers in FIGS. 11-23 which are the same refer to the same or similar element and thus will not be described with respect to each figure for the sake of brevity.

FIG. 11 is a diagram 1100 showing the exemplary robotic device 300, e.g., robotic forklift on flat ground 1102. Fork distance D 1106 associated with the robotic forklift corresponds to the length of the forks. P 1104 is used to indicate the parking location, e.g., the location of the robotic device 300 main body from which the forks can be extended, raised, lower and/or titled (e.g., by tilting the mast to which the fork assembly is attached in some embodiments).

FIG. 12 is a diagram 1200 showing how the forks of the robotic device 300 of FIG. 11 can be extended out and away from the main body of the forklift 300, e.g., extending the scissor like fork extension mechanism 397. By extending the extension mechanism 397 the forks having a length D 1106 are extended out an extension distance E 1202 with the distance D+E 1108 representing the combination of extension distance E and fork length distance D.

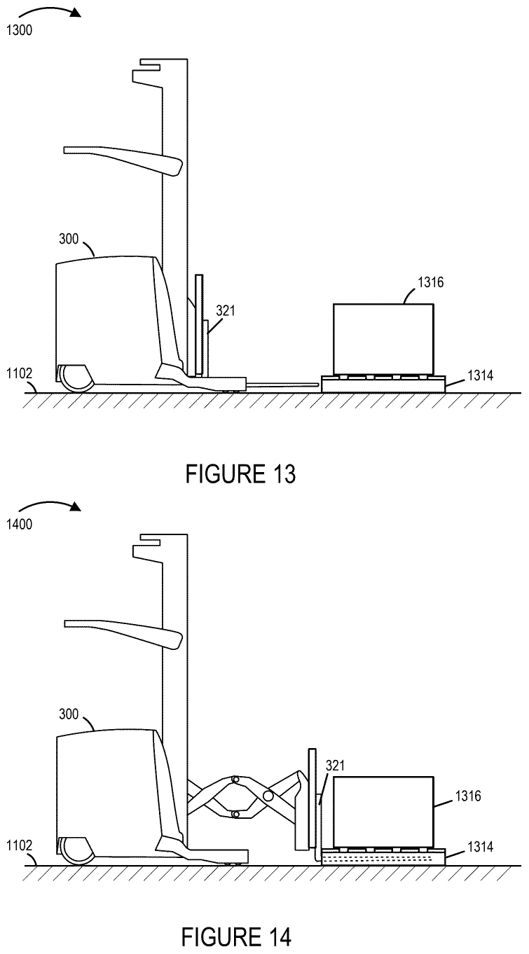

FIG. 13 is a diagram 1300 which shows the robotic forklift 300 of FIG. 11 on level ground 1102 in a position where it is close to a pallet 1314 and preparing to initiate a pallet pick up operation to lift and move the pallet 1314 with the goods 1316.

FIG. 14 is a diagram 1400 showing the robotic forklift 300 of FIG. 11 on level ground 1102 with the forks extended as part of a pallet pick up operation with the pallet 1314 being nested in the forks and ready for lifting from the ground 1102. Note that full nesting has been achieved with no gap being visible between the pallet 1314 and fork backrest 321.

FIGS. 13 and 14 shows an example of operation on level ground 1102 where the forklift 300 can come close to the pallet 1314 to be picked. Thus FIGS. 13 and 14 are an example where the pickup operation can be implemented without the need for a double pick operation but where the pallet position sensor 305 still being used to confirm full nesting of the pallet 1314 against the backrest 321 prior to the robotic device 300 moving with the pallet to a new location.

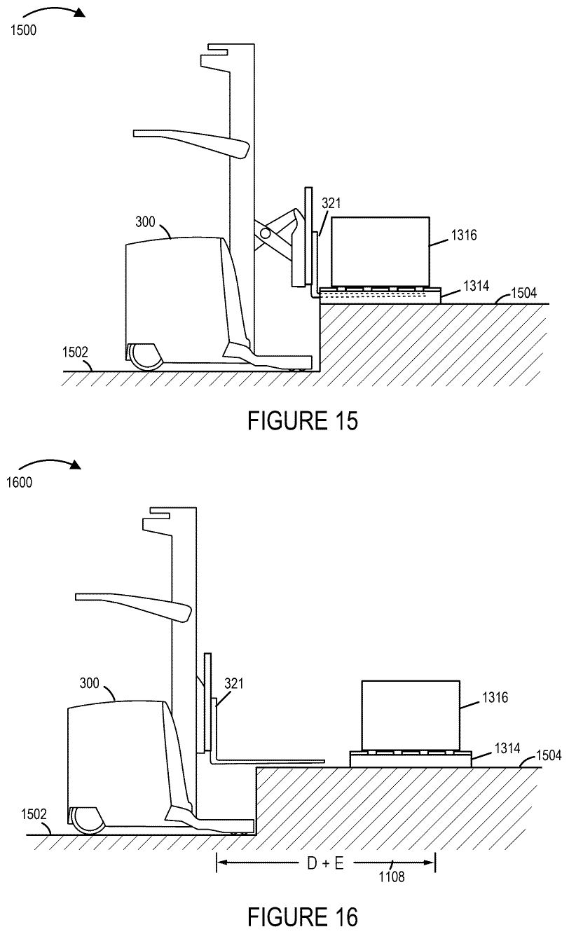

FIGS. 15-23 show operation of the robotic forklift 300 in an area in which the forklift's ability to approach the pallet 1314 to be picked up and moved is obstructed, e.g., by a step. The ground 1502 on which the forklift 300 operates is below the step 1504 on which the pallet 1314 is located and limits where the forklift 300 can park to implement the pickup operation. The step is merely exemplary of an obstruction that might limit forklift placement. Obstacles, rack overhangs, and/or pallets extending out from a multi-level storage rack might also limit the ability to position the forklift 300 close to the pallet to be picked up.

In FIG. 15 drawing 1500 shows the pallet 1314 to be picked up close to the edge of step 1504 and in a position allowing for a pickup from the step 1504 in a single pick operation.

In contrast to the FIG. 15 example, in the drawing 1600 of FIG. 16, the pallet 1314 is shown set back from the edge of step 1504 making it difficult for the forklift to reach, pickup and achieve nesting of the pallet 1314 in a single pickup operation. FIG. 16 shows an example where a decision may be made to perform a double pick procedure or the double pick procedure may be triggered automatically by sensor 305 failing to achieve nesting after an initial pickup attempt.

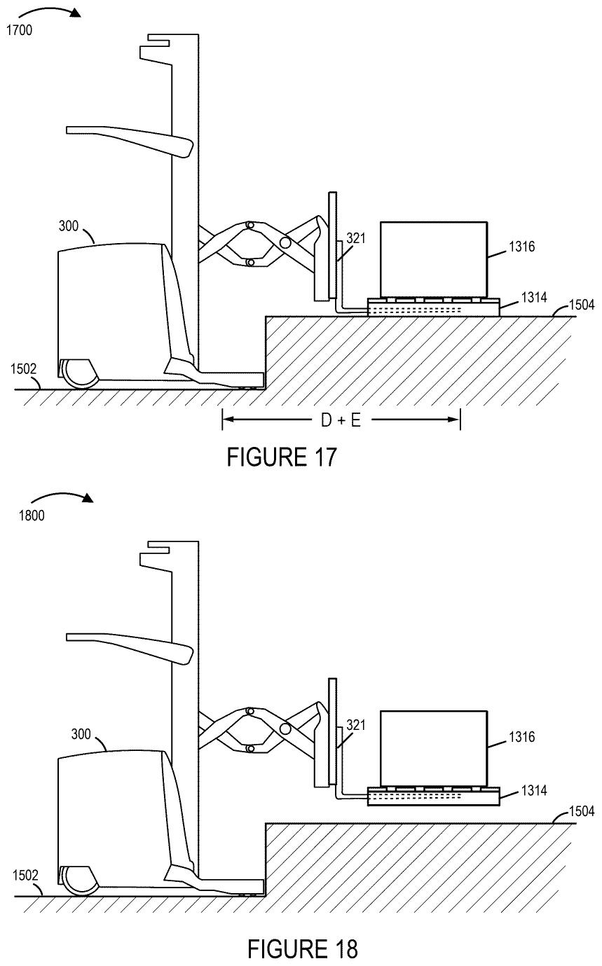

FIG. 17 shows a diagram 1700 in which the robotic forklift 300 is performing the first step of a two bite (e.g., double bite) pickup procedure in which the pallet 1314 will be raised, moved, lowered and the forks reinserted to achieve proper pallet nesting before the robotic forklift 300 moves to take the pallet 1314, and goods 1316 positioned thereon, to a new location. In FIG. 17 the forks are being extended into the pallet 1314, but full nesting is not achieved as shown by the gap between the pallet 1314 and backrest 321.

FIG. 18 shows the robotic forklift 300 lifting the pallet 1314 shown in FIG. 17 with the pickup fails to achieve nesting. The sensor 305 will detect the failure to achieve full nesting, e.g., in step 1024, and operation will proceed based on the sensor failure to detect proper nesting.

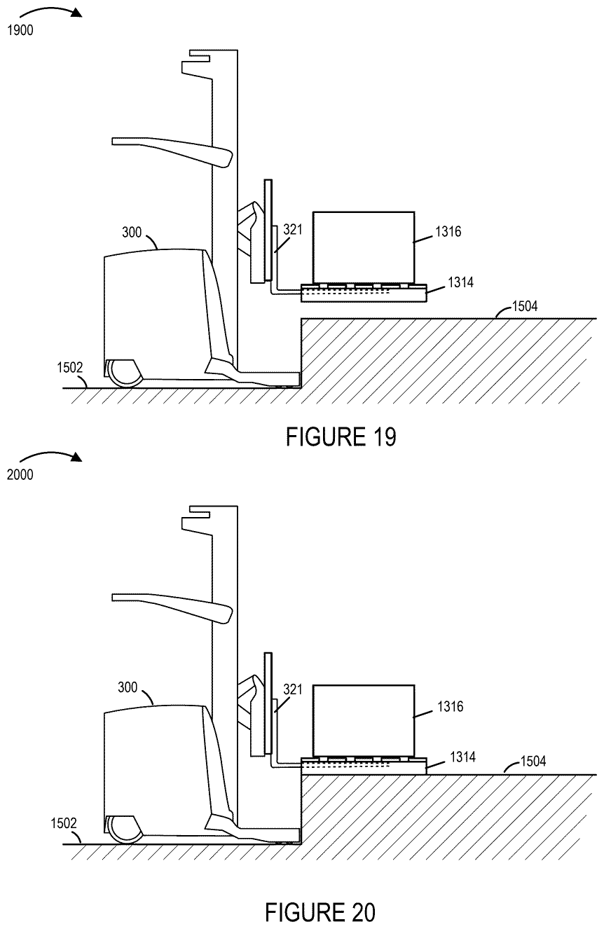

FIG. 19 is a diagram 1900 showing the robotic forklift 300 retracting the pallet forks to move the pallet 1314 closer to the forklift 300 while the pallet 1314 is in the air so it can be lowered and repositioned as part of the double bite pickup procedure. FIG. 19 corresponds to step 1016 of FIG. 10.

FIG. 20 is a diagram 2000 showing the robotic forklift 300 after it has lowered the pallet 1314 to the ground as part step 1018 of the double bite pickup procedure discussed with regard to FIG. 10.

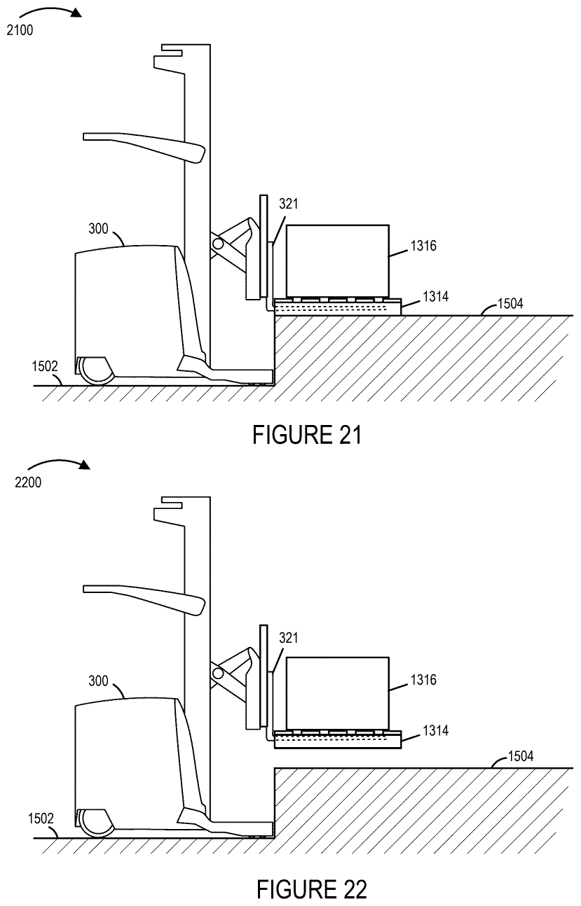

FIG. 21 is a diagram showing the forks of the robotic device 300 re-inserted into the pallet 1314 to achieve full nesting of the pallet 1314 as part of the double bite pickup procedure. The reinsertion is part of the pallet pickup operation 1020 of FIG. 10.

FIG. 22 is a diagram 2200 showing the pallet 1314 having been lifted following full nesting of the pallet 1314 as part of the double bite pickup procedure and now being ready for transport. As a result of successful pallet nesting, in step 1024 the processor controlling the robotic forklift 300 will determine based on the output of pallet position sensor 305 that the pallet is fully nested and can be safely transported to the intended pallet destination.

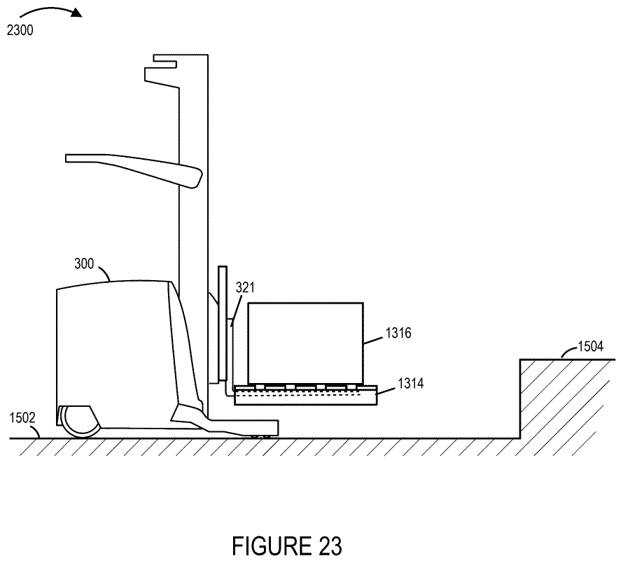

FIG. 23 is a diagram 2300 showing the pallet 1314 fully nested and being transported by the robotic forklift 300 to a new location away from the raised step 1504 where the pallet 1314 was previously stored. FIG. 23 corresponds to and represents the transport performed in step 1026 of FIG. 10.

In various embodiments, a combination of sensors, e.g., a camera array 392 and/or other 3D sensors (e.g., radars 380, 382, 384 and/or Lidar units 386, 388, 390), are used to determine information about the size, shape and/or location of, e.g., a pallet of goods to be moved and/or a location where the goods are to be placed. In various embodiments a camera array 392 and/or other sensors 380, 382, 384m 386, 388, 390 is used to capture information, e.g., images or measurements, of the goods and/or a location where the goods are to be placed. In some embodiments stereoscopic analysis of the captured images and/or analysis of the output of other sensors radars 380, 382, 384 and/or Lidar units 386, 388, 390, provides 3D information about the pallet of goods and/or placement location.

A check is made to determine the 3D space, e.g., volume occupied by the goods being moved and outer dimensions of the volume. A similar analysis is made of the location, available storage space in a pallet rack, where the goods are to be placed. A check is made to determine if the goods will fit in the available space based on the 3D analysis of the goods and location where the goods are to be placed.

In some embodiments a first image and/or representation of the pallet of goods being moved is displayed to a material handling operator, e.g., a robotic forklift operator working at an operator workstation 200 from which the robotic device 300 can be manually controlled during periods of operation in which the device 300 is not operating autonomously.

In some embodiments, an image of a pallet with the goods being moved is displayed along side, in front of, or superimposed on an image or representation of the area where the goods are to be placed. Cuboids or other 3D shapes corresponding to the outside edges of the pallet and goods being moved are sometimes determined and used to indicate the volume which is expected to be occupied by the pallet and goods being moved and/or the volume available for storing the pallet of goods being moved. The 3D shape corresponding to the pallet of goods being moved, when displayed, helps an operator visually recognize the edges of the pallet and goods as well as the edges of the storage area along with potential impact areas. Areas of potential collision or impact are highlighted using colors or other visual indicia to help the operator focus his/her attention on areas of concern.

In various embodiments, an image of the pallet with goods, a 3D shape corresponding to the determined volume of the pallet with goods, a 3D shape corresponding to the available storage area, and/or an image of the storage area where a pallet with goods is to be placed is displayed to an operator, e.g., at an operator workstation 200 used to control the robotic device 300.

Portions or areas of the pallet with goods, which are likely to suffer an impact during placement, are highlighted in some embodiments, as they are displayed, using coloration and/or shading to draw attention to areas of predicted impact or potential impact.

In some embodiments an image of the area where the goods are to be placed, is displayed alongside or behind the image of the goods to be moved, e.g., with the pallet of goods being superimposed on an image of the storage location in some embodiments. As noted above, in various embodiments the areas of potential impact are highlighted or otherwise identified to the operator. In this way a human operator is made aware of areas of concern. The operator can respond to indications of potential collisions with objects in the area where a pallet or other item is being moved by repositioning the pallet so that it will safely fit in the space or by choosing a new location to store the goods/pallet.

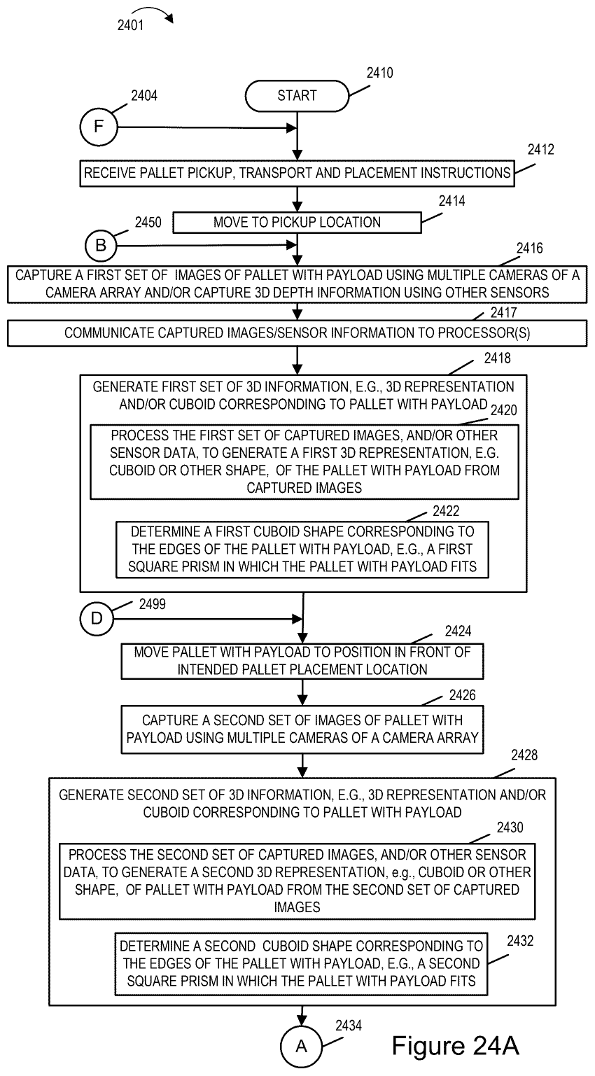

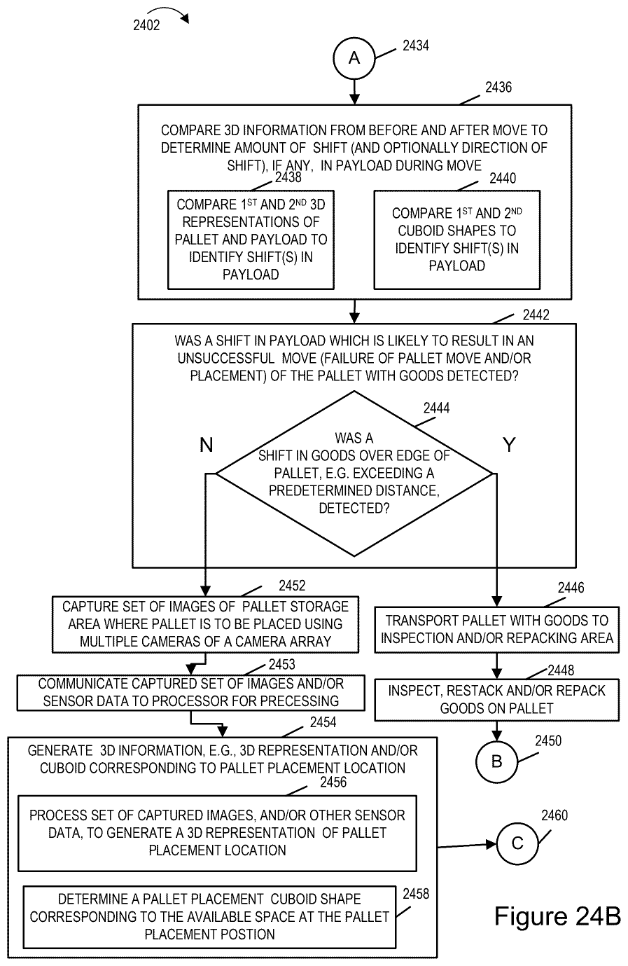

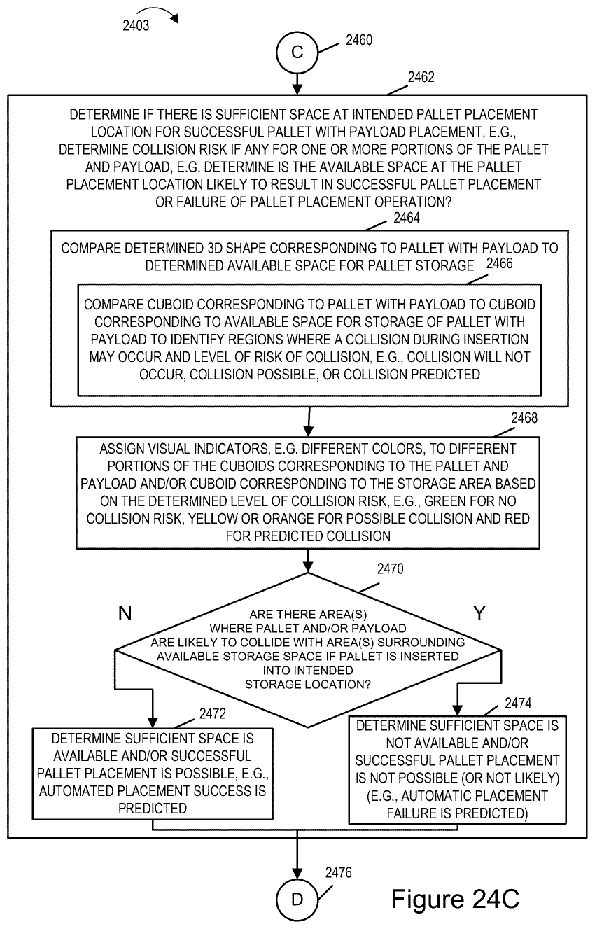

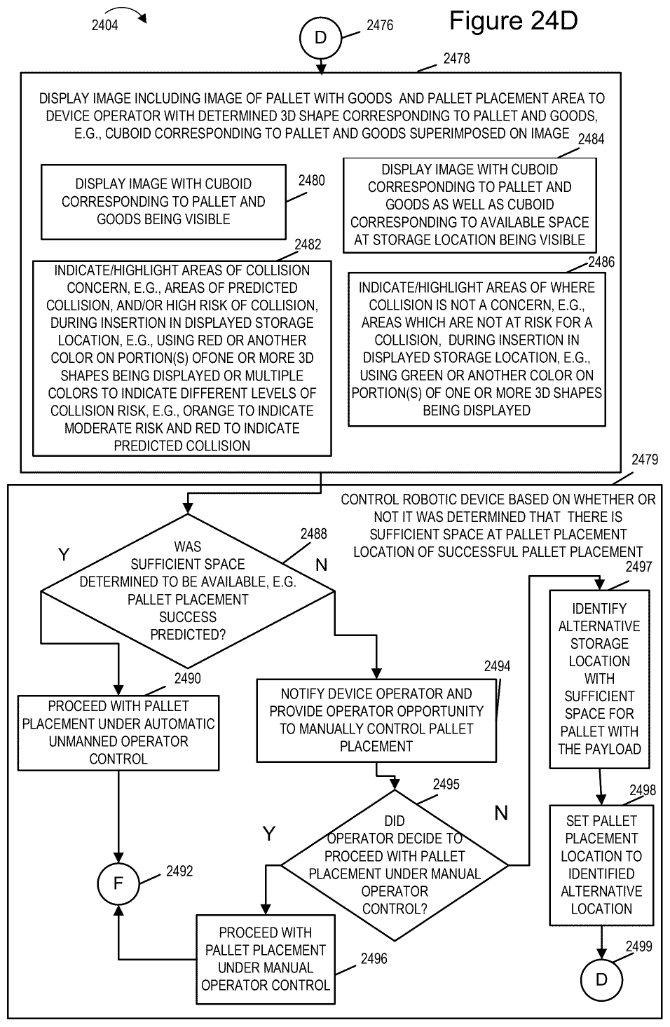

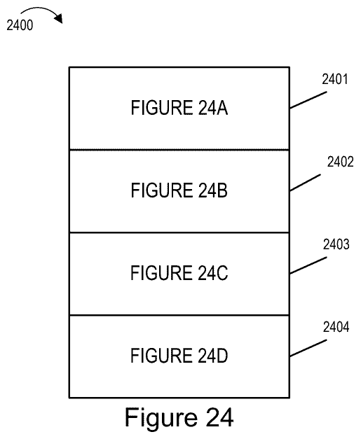

An exemplary method in which the 3D shape of a pallet with goods being moved is determined and checked against the available space at the location where the pallet of goods is to be placed will now be explained with reference to FIGS. 24A, 24B, 24C and 24D and FIG. 24.

FIG. 24 shows a diagram 2400 showing how the diagrams 2401, 2402, 2403 and 2404 of FIGS. 24A, 24B, 24C and 24D can be combined to form a complete flow chart showing steps of an exemplary method.

The method starts in step 2410 of FIG. 24A with a robotic device 300, e.g., a forklift capable of operating in an autonomous mode or under direction of a human operator, e.g., working at an operator workstation 200, being powered on and placed in a state in which it is ready to receive instructions, e.g., commands, and perform operations. Operation proceeds from start step 2410 to instruction receipt step 2412 in which the robotic device 300 receives instructions, e.g., in the form of a set of commands from a control system and/or operator workstation 200 which assigns operations, e.g., pallet pickup, transport, e.g., move, and place operations, to be performed to robotic device 300.

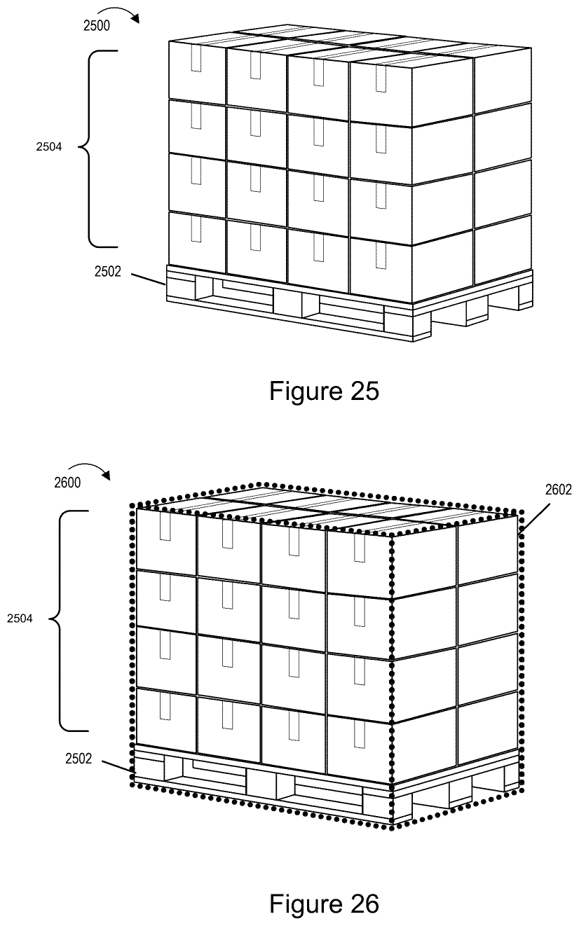

FIG. 25 is a diagram 2500 illustrating an exemplary pallet 2502 with payload 2504, a set of boxes, which can be picked up and moved in accordance with instructions received in step 2412.

Operation proceeds from step 2412 to step 2114 in which the robotic device 300 moves to the pallet pickup location where it will position itself to pick up a pallet, e.g., with a payload such as a stack of boxes. The robotic device 300 may and sometimes does stop at the pallet pickup location, e.g., directly in front of the pallet 2502, to capture images of the pallet 2502 with payload before the forks of the robotic device 300 are inserted into the pallet 2502.

With the move to the pallet pickup location complete operation proceeds to step 2416 in which a first set of images of the pallet 2502 with payload 2504 is captured, e.g., the cameras 392, 294, 396 which are positioned at various locations on the robotic device 300. Since the cameras are spaced apart from one another at known distances, stereoscopic processing of the images can be used to obtain 3D depth information about the pallet and payload. In addition to capturing images, in step 2416 other sensors, e.g. radar units 380, 382 384 and/or LIDAR units 386, 388, 390 can be activated and used to capture depth information which can be used to generate a 3D representation of the pallet 2502 with payload 2504.

With the first set of information sufficient to determine the 3D shape of the pallet 2502 with payload 2504 to be moved having been captured in step 2416, e.g., by the cameras and/or sensors on the robotic device 300, operation proceeds to step 2417 in which the captured information is communicated back to the operator workstation 200 for processing by the processor 202 and/to the processor 305 in the robotic device 300.

Operation proceeds from step 2416 to store 2418 in which a first set of 3D information, e.g., a representation of the actual shape of the pallet 2502 and payload 2504 or a cuboid shape, e.g., such as the cuboid 2602 shown in FIG. 26, corresponding to the outer perimeter of the pallet 2502 and payload are generated, e.g., by a processor which received the information captured in step 2416 at the operator workstation 200 or within the robotic device 300. Step 2418 in some embodiments includes one or more of steps 2420 and 2422. In step 2420 the first set of captured images is processed to generate a first 3D representation of the pallet 2502 with payload 2503. Stereoscopic processing maybe and sometimes is used in step 2402 to generate the 3D representation of the pallet 2502 with payload 2504. In other embodiments step 2420 processes captured images and combines it with lidar and/or radar data to generate the 3D representation while in other embodiments simply lidar or radar information is used to generate the 3D representation of the pallet and payload produced in step 2420.

In step 2422 a 3D shape, e.g., a cuboid, corresponding to the perimeter of the pallet 2502 with payload 2504 is generated from the images and/or sensor data. Use of a cuboid shape rather than a detailed 3D model of the observed pallet and payload has the advantage of allowing for simplified comparisons of volumes when a cuboid is also used to represent the available space at the storage location where the pallet 2502 with payload 2504 is to be placed.

Referring now briefly to FIG. 26, FIG. 26 is a diagram 2600 of the exemplary the pallet 2502 with payload 2504 of FIG. 25 with a 3D shape 2602, e.g., a cuboid shape, corresponding to outer edges of the pallet with payload shown. The cuboid 2602 is the shape that was determined from captured images and/or other sensor date in step 2418. The pallet 2502 with payload 2504 and corresponding shape 2602 is in some embodiments displayed on the display of the operator workstation 200 to an operator who controls pallet movement from the operator workstation 200, The display of the captured image of the pallet and payload along with the cuboid shape superimposed thereon help the operator understand the volume which will be required at a storage location to store the pallet 2502 with goods 2504.

With a 3D representation of the pallet 2502 with payload 2504, before the transport of the pallet 2502 to the placement location, having been generated in step 2418, operation proceeds to step 2424. In step 2424 the pallet 2502 with payload 2504 is picked up and moved by the robotic device 300, e.g., robotic forklift, to the intended pallet placement location indicated by the information received in step 2412. The pickup and movement maybe and sometimes is implemented as an autonomous mode forklift operation but can be performed under operator control in some cases.

The robotic device 300 stops at the pallet placement location before moving the forks of the robotic device 300 to insert the pallet and payload into the intended storage location.

In some but not all embodiments a check on the payload is made to determine if it shifted while being moved. While this check is optional and involves capturing additional images and generating a second 3D representation or object corresponding to the pallet 2502 and payload 2504 it is useful in those cases where concern about goods shifting during movement of the pallet is an issue. The FIG. 24 example includes such a check with additional images and an additional set of 3D information being collected and used to generate a second 3D representation of the pallet 2502 and payload 2504 to determine if a shift in goods, e.g., a above a predetermined amount/distance, merits additional inspection and/or repacking of the payload 2504 on the pallet.

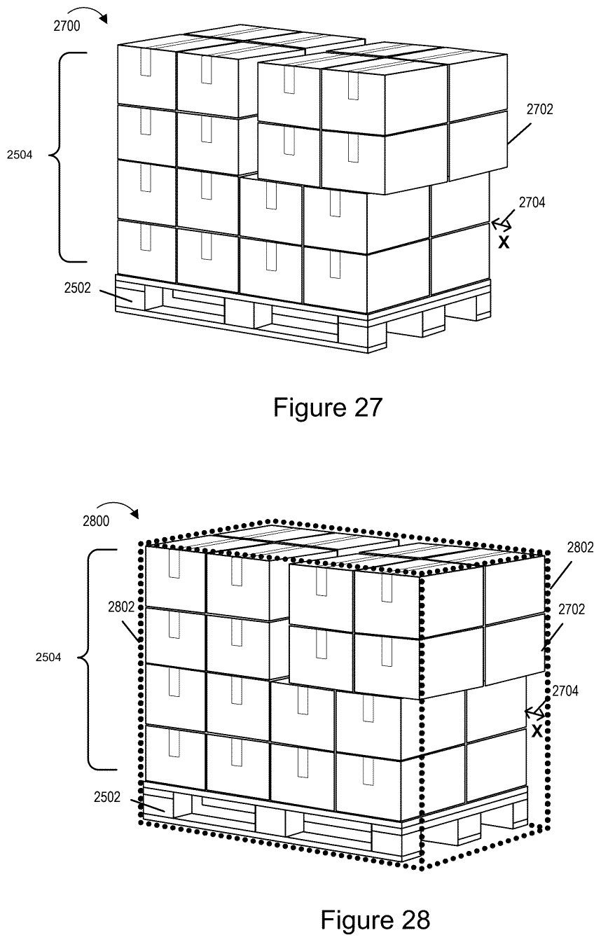

FIG. 27 represents the type of image(s) that may be captured after movement of the pallet 2502 with goods 2504. Referring now briefly to FIG. 27, FIG. 27 illustrates the exemplary pallet with payload of FIGS. 25 and 26 with some of the boxes 2702 on the pallet having shifted, e.g., to the right, during the move from the original pallet pickup location. Note that the set of 4 shifted boxes corresponding to reference number 2702 extends beyond and over the right side of the pallet 2502 with X 2704 representing the distance the boxes shifted to the right. As a result, the shift in boxes the volume required to store the pallet 2502 and payload 2504 is now larger than when it was originally picked up.

Referring once again to FIG. 24A, if a check of whether the goods shifted is not to be made, steps 2426 to 2448 can be skipped with operation proceeding directly from step 2424 to step 2452. However, in embodiments such as the one shown in FIG. 24 where a check is made to determine if the goods shifted while being moved, operation proceeds from step 2424 to step 2426 in which a second set of images and/or 3D sensor data of the pallet 2502 and payload 2504 is made. In step 2426 a second set of images of the pallet 2402 and payload 2504 is captured before operation proceeds to step 2428 which involves the same or similar operation to those performed in step 2418 but with the processing using the second set of images, e.g., images showing any shift.

In step 2428 after being communicated to the processor which is doing the processing, the images and/or other sensor data captured in step 2426 is processed to generate a second 3D representation, e.g., cuboid or model, corresponding to the pallet 2502 with goods 2504. In some embodiments step 2428 includes one or both of steps 2430 and 2432. In step 2430 the second set of captured images and/or other sensed data is processed to generate a second 3D representation of the pallet 2502 with payload 2504. This representation will reflect the shift in goods 2702 that occurred when the pallet 2502 was moved from the pickup location to the intended storage location. In step 2458 a cuboid shape, such as the cuboid 2802 shown in FIG. 28 is generated corresponding to the perimeter of the pallet 2502 and goods 2504.

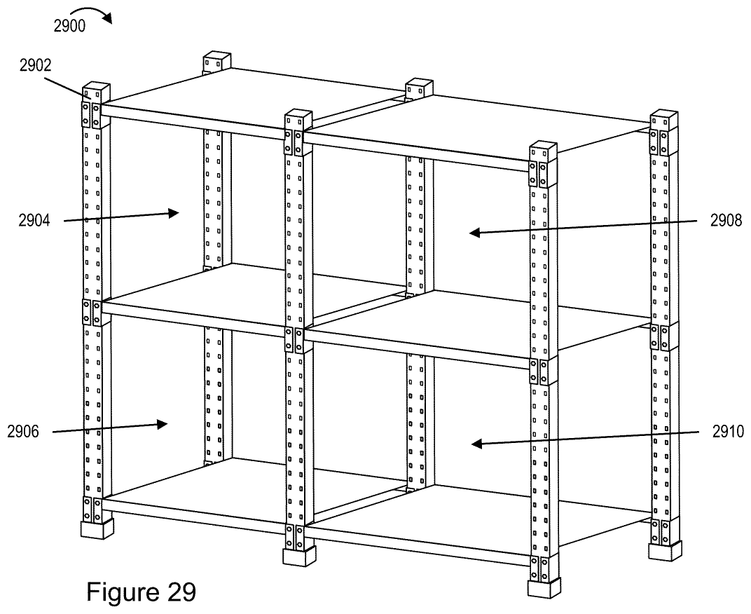

Referring now briefly to FIG. 28, it can be seen that FIG. 28 is a drawing 2800 that illustrates the exemplary the pallet 2502 with payload 2504 of FIG. 27 that shifted position during transport. The 3D shape 2802, corresponding to outer edges of the pallet 2504 with payload, was determined in step 2428 and in step 2432 in particular. A captured image of the pallet 2502 with the payload 2504 showing the shifted goods 2702 with the cuboid 2802 is displayed in some embodiments to an operator using the operator workstation 200 to help the operator appreciate that shift in goods. Note that while the left, top, front and rear perimeter of the payload 2504 remains the same but the right side has now extended by the distance X as compared to in the FIGS. 25 and 26 examples. Thus, the cuboid 2802 used to represent the outer perimeter of the 3D volume which will be used or required to store the pallet 2502 and payload 2504 is now X inches larger on the right side than it was in the FIG. 26 example. FIG. 29 is a drawing 2900 showing an exemplary pallet rack 2902 which includes four storage locations 2904, 2906, 2908 and 2910 for storing goods. For purposes of explaining the invention the upper left storage location 2904 will be used as the initial intended storage location into which the pallet with goods 5404 is to moved with the upper right storage location 2908 being an alternative storage location that is also empty available for use.

The storage location 2904 may be and sometimes is initially selected as the location to which the pallet 2502 with goods is to be moved since the pallet 2502 can fit in the location if none of the goods on the pallet extend over the edge of the pallet 2502.

Referring once again to FIG. 24A, operation proceeds from step 2428 to step 2436 of FIG. 24B via connecting node 2434.

In step 2436 3D information corresponding to the pallet 2502 with payload 2504 corresponding to the shape before and after the move is compared to determine the amount of shift, if any, in the goods 2504 on the pallet which occurred during the move. In various embodiments step 2436 includes one or both of steps 2438 and 2440. In step 2438 the first and second 3D representations, e.g., models corresponding to before and after the move, of the pallet 2502 and payload 2504 are compared to identify any shift(s) in the payload. In step 2440 the 1st and 2nd cuboids shapes, e.g., the shapes corresponding to before and after the move, are compared to identify any shift(s) in the payload 2504.

Based on the comparison(s) performed in step 2426, as applied to the examples shown in FIGS. 26-28, a shift of x inches to the right of at least some of the good 2504, e.g., the boxes 2702, will be determined with no other shift being detected.

With any shift of goods due to transportation between the pickup and intended placement site having been detected and measured in step 2436 operation proceeds to step 2442 in which a check is made to determine if a shift in payload which is likely to result in an unsuccessful move, e.g., failure of the pallet move due to goods falling off the pallet and/or a pallet placement is likely to be unsuccessful due to a shift in goods is made. In some embodiments step 2442 includes checking a detected amount of shift in the goods to determine if it exceeds a predetermined distance which is likely to result in a placement failure or goods falling off the pallet. This involves in some embodiments the shift distance X determined in step 2436 being compared to a threshold value, e.g., a set number of inches, which when exceeded is likely to result in a placement failure (e.g., due to the goods sticking too far over the edge of the pallet increasing the chance of a collision during placement and/or the goods falling off as the pallet is inserted into the storage location).

If in step 2442 it is determined that a shift in payload is likely to result in an unsuccessful placement or move, e.g., because in step 244 it is determined that a shift exceeds the predetermined maximum safe shift in goods, operation proceeds to step 2446 in which the robotic device 300 is controlled to transport the pallet 2502 with goods 2504 to an inspection and/or repacking area, e.g., by a command from the operator workstation 200 or processor of the robotic device 200. Note that the shift in goods may create a risk of failure even if the shifted goods and pallet can still fit in the space available at the intended storage location. Accordingly, the check for a goods shift can be separate from and in addition to a later check as to whether the pallet 2502 and shifted goods will fit in the intended storage location 2904.

After reaching the inspection area the goods 2504 are inspected, restacked and/or repackaged so that they are securely stored on the pallet 2502. From step 2448 operation proceeds via connecting node 2450 to step 2416 where images of the pallet with payload are captured by cameras 392, 294, 396 and/or measurements by other sensors such as sonar/radar/lidar sensors 374, 376, 380, 382, 386, 388, 390 are captured before the repacked pallet 2502 is moved from the inspection/repacking area to the intended storage location.

Referring once again to step 2442 if a shift in payload which is likely to result in an unsuccess move and/or pallet placement is not detected, e.g., the goods did not shift during transport and/or it is determined in step 2444 that the amount of shift does not result in the goods extending over the edge of the pallet 2502 by the predetermined amount, operation proceeds to step 2452. While the shift may not result in the goods extending over the edge of the pallet 2502 by the amount which would automatically trigger inspection/repacking, they may extend slightly over the edge of the pallet 2502 due to a shift of less than the predetermined distance that triggers an inspection.

In step 2452 a set of images of the pallet placement areas where the pallet 2502 with goods is to be placed is captured, e.g., using multiple cameras included in one or more of camera system 392, 294, 396 and/or other sensor data such as sonar, lidar and/or radar sensor data is captured, e.g., using sonar, radar and/or lidar units, to allow the shape and volume of the pallet placement area to be determined.

In the case of the FIG. 29 pallet rack 2902, images and/or other sensor data are captured in step 2541 and used to generate 3D measurements of pallet storage areas 2904, 2906, 2908 and 2910.

Operation proceeds from step 2452 to step 2453 in which the captured images/sensor data are communicated to a processor, e.g., the processor 202 of the operator workstation 200 or the processor 306 of the robotic device 300 for processing. The processor to which the captured images/sensor data is sent is normally the same processor to which was used to perform steps 2418 and/or step 2428 which involved generation of the 3D model or other 3D representation of the pallet 2502 with payload 2504. With images and/or other sensor data having been captured in step 2452 operation proceeds to step 2454 in which 3D information, e.g., a 3D representation and/or cuboid corresponding to the intended pallet placement location is generated from the captured images and/or sensor data collected in step 2452.

Thus, operation proceeds from step 2453 to step 2454 in which the processor to which the images/sensor data were communicated generates 3D information corresponding to the pallet placement location, e.g., a 3D representation of the available space for storing the pallet or a cuboid corresponding to the perimeter of the available space, e.g., the inside unobstructed volume of a slot in a pallet rack into which the pallet can be inserted. In some embodiments step 2454 includes one or both of steps 2456 and 2458. In step 2456 the processor processing the set of images/sensor data corresponding to the intended pallet storage location generates a 3D representation of the pallet placement location, e.g., a 3D model of the available space. In step 2458 the processor determines a cuboid shape corresponding to the available space at the pallet placement location. A cuboid is a three-dimensional shape which is a convex polyhedron that is bounded by six rectangular faces with eight vertices and twelve edges. A cuboid is also sometimes called a rectangular prism. An example of a cuboid in real life is a rectangular box. The cuboid shape is, in essence, a simplified 3D representation of the available space since it has flat sides and is a reasonable representation of the area into which a pallet and payload can be inserted without the complexities of a more precise 3D model which may have curved or unusually shaped surfaces.

A cuboid can be easily determined as opposed to a more complex model of the available space and/or pallet with goods and is therefore used in some embodiments to represent the space required for the pallet with goods as well as the available space at a pallet storage location. Cuboids can also be easily compared to determine if one cuboid will fit inside another. This makes the use of cuboids for the pallet with goods as well as the storage location well suited for use in determining if sufficient space is available to store the pallet 2502 with goods 2504.

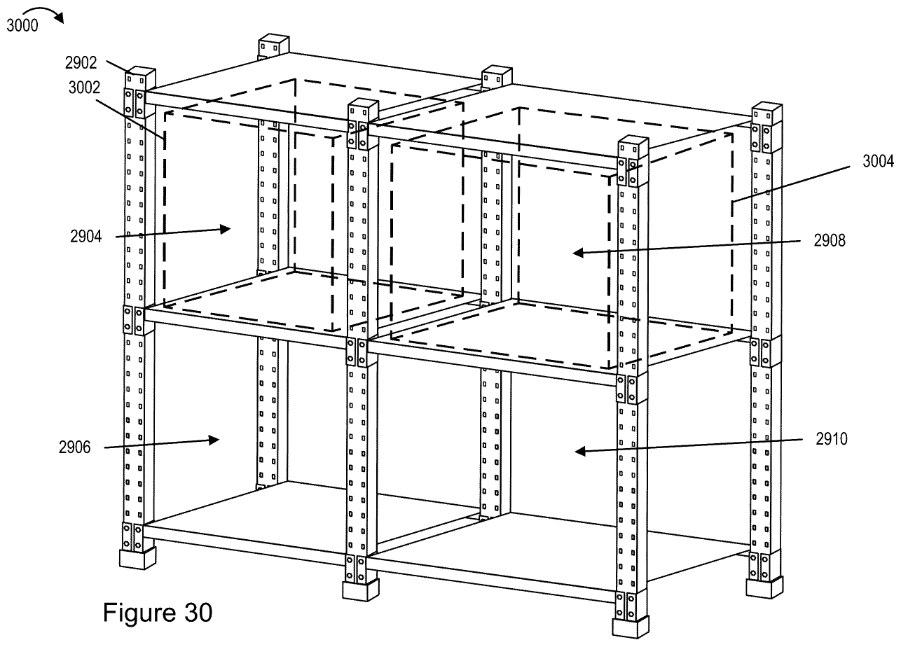

FIG. 30 is a diagram 3000 showing the pallet rack 2902 with storage locations 2904 and 2908 and corresponding cuboids 3002, 3004, respectively which are determined in step 2454. Cuboid 3002 is a 3D representation of the available storage space at storage location 2904 while cuboid 3004 is a 3D representation of the available storage space at storage location 2908. Note that is a product or other obstruction were present in a location the cuboid corresponding to the storage location would be reduced in size to avoid the obstruction resulting in a much smaller cuboid than the one shown since the available space would be reduced by the presence of the object/obstruction. This may be the case when a box or other item fell off a pallet previously stored in the location and/or off a pallet located to the side or behind the storage location. The 3D check of the available space will detect the presence of such an unexpected object before the pallet is inserted thereby avoiding a collision or product damage.

With a 3D representation of the available space for pallet and payload placement having been generated in step 2454 operation proceeds via connecting node C 2460 to step 2462 shown in FIG. 24C.

In step 2462 a check is made to determine if there is available space at the intended pallet placement location for the pallet 2502 with the payload 2504. Step 2463 in some cases determining if there is a collision risk between the pallet and payload and pallet rack/previously stored goods and, if so, what portions of the pallet 2502 and payload 2504 are at risk of a collision during placement of the pallet and payload in the storage location so that the portions at risk can be, and in some embodiments are visually highlighted to an operator controlling robotic device operation such as pallet placement., e.g., with the operator workstation using red or other coloring to highlight/indicate areas at risk of a collision.

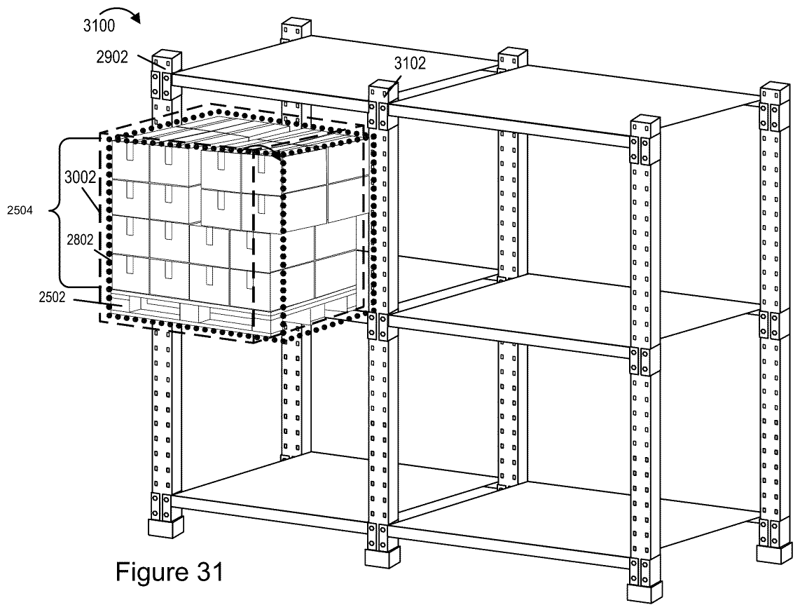

In some embodiments step 2462 includes one, more or all of steps 2464, 2468, 2470, 2472, 2474 which are implemented by the processor 202 in the operator workstation 200 and/or the processor 306 in the robotic device 300. In step 2464 which in some embodiments is part of step 2462, the 3D shape 2802 corresponding to the pallet 2502 with payload 2504 is compared to the determined available space/volume for pallet storage at the storage location where the pallet is to be placed, e.g., which in the example shown in FIG. 31 is represented by the 3D shape 3002 included in the diagram 3100. This is to determine if the pallet 2502 with goods 2504 will fit in the available storage space where the pallet with goods is to be placed. In some embodiments step 2464 includes step 2466 in which a cuboid shape 2802 corresponding to the pallet 2502 with goods 2504 is compared to a cuboid shape 3002 corresponding to the available storage space. The cuboid 2802 corresponding to the pallet 2502 with payload 2504 should be smaller on all sides than the cuboid 3003 corresponding to the available storage space, e.g., by a predetermined safety margin in terms of size, e.g., 6 inches or a foot for example, with the cuboid for the pallet 2502 with goods 2504 required in some embodiments to be at least 1 foot smaller on all sides than the cuboid corresponding to the available storage space. A distance of less than the predetermined safety margin indicates a possible or likely collision on a given side. While 1 foot safety margin is used as an example smaller or larger safety margins are possible, e.g., depending on how controllable the robotic device is and the level of precision with which placement operations can be made.

As a result of the comparisons made in step 2464, areas, e.g., sides, where collisions might occur and the probability of a collision is determined, e.g., with higher probability of a collusion the smaller the space difference between the side of the pallet 2502 with payload 2504 and the side the storage area into which it is inserted. When there is no predicted space between the side of the pallet 2502 with payload 2504, e.g., because the pallet with payload is larger on one side than the space available on that side, a collision is predicted.

Operation proceeds from step 2464 to step 2468 in which visual indicators, different colors, are assigned to different portions, e.g., sides/top/bottom, of the 3D shapes, corresponding to the pallet 2502 with payload 2504. The visual indicator, e.g., color indicates the risk of collision. For example, in some embodiments red is used to indicate an expected collision, green to indicate a safe area and orange to indicate an area where a collision might occur if the pallet is not carefully moved in position in the storage location. The visual indications can be and sometimes are displayed to an operator controlling the movement of the robotic device by highlighting and coloring portions of cuboids on a display screen presented to the operator at the operator workstation 300.

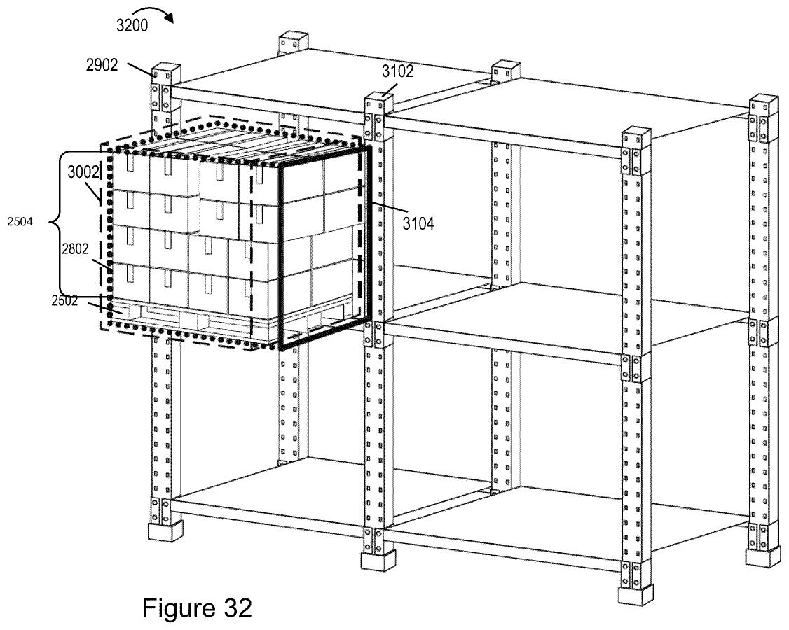

FIG. 32 is a diagram 3200 which includes an image of the pallet rack 2902, pallet 2502 with goods 2504 and cuboids 3002, 2802 with the right side 3104 of the cuboid 2802 being highlighted/indicated in red, represented by the dark black lines forming the right side edges of the cuboid 2802. The visual indication 3104 is intended to visual indicate to an operator of an operator workstation on which the drawing 3200 is displayed that a collision is predicted on the right side of the pallet 2502 with payload 2504 if it is inserted into the top left pallet storage location. This predicted collision is with pallet post 3102 and is due to the shift of goods, i.e., the top four right side boxes, when the pallet 2502 was moved.

Operation proceeds from step 2468 to step 2470 in which an automatic check is made by the processor of the operator workstation 200 or robotic device 300 to determine if a collision will happen or expected to happen if the pallet is inserted into the intended storage location. This check may and sometimes does involve checking if there is at least the predetermined safety margin of distance, e.g., 1 foot, available on all sides of the pallet and payload at the storage location. If there is no safety margin or a space less than the predetermined safety margin on any side or the top, a decision is made in step 2470 that a collision will happen (e.g., in the case of no safety margin on a side) or is likely to happen (in the case of a distance less than the predetermined safety margin being available on one side or top of the pallet 2502 and payload 2504.

If in step 2470 it is determined that a collision will occur or is likely to occur, operation proceeds via the Y decision path to step 2474 in which the processor performing the check determines that sufficient space is not available for successful pallet placement. However, if in step 2470 it is determined that a collision will not happen or is unlikely to happen, e.g., because there is at least the predetermined safety margin in terms of space on all sides and the top of the pallet 2502 with payload as compared to the storage location, operation proceeds from step 2470 via N path and in step 2472 it is determined that there is sufficient space available for the placement of the pallet 2502 with payload 2504.

Operation proceeds from step 2472 (placement success predicted) and 2474 (placement predicted to fail) to step 2478 of FIG. 24D via connecting node D 2476.

In step 2478 an image, e.g., an image such as diagram 3200 shown in FIG. 3200, is displayed to the operator working at the operator workstation 200 used to control the robotic device to provide the operator with information about the space available for pallet placement and the size of the pallet along with areas where collisions are possible or expected. The display operation can take many forms with the operator being presented with the 3D shapes (cuboids) corresponding to the pallet 2502 with payload 2504 and/or the storage location where the pallet is to be placed along with an image of the pallet and/or image of the storage location. Such images and shapes can be and sometimes are superimposed on each other and/or displayed side by side or one in front of the other to facilitate a spatial understanding of how the pallet 2502 with payload 2504 needs to be manipulated/moved to store it in the intended storage location, e.g., in an available space of a pallet rack. The display operation of step 2478 will occur when a failure is predicted and operator oversight/control is to be implemented. However, when successful placement is predicted, display step 2478 is optional and in some embodiments the placement of the pallet is performed autonomously without operator involvement. In such a case step 2478 can and sometimes is skipped since an operator need not be involved in the placement operation or control of the robotic device.

Step 2478 in some embodiments includes one, more than one, or all of steps 2480, 2482, 2484 and 2486. In step 2486 an image is displayed to the operator of the operator workstation 200 of the pallet 2502 with payload 2504 along with the cuboid corresponding to the 3D shape of the pallet and goods. In step 2882 areas of collision concern, areas where an actual or possible collision are expected, are highlighted or otherwise indicated visually, e.g., using different colors to indicate different levels of risk of collision such as red for predicted collision, orange for possible collision and green for no collision expected. The colors may be and sometimes are applied to the sides of the cuboid corresponding to the pallet with payload to indicate the area of the pallet and/or payload at risk of collision and to draw the operators attention to such areas.

In step 2484 an image showing the cuboid corresponding to the pallet 2502 with payload 2504, is displayed along with an image of the pallet 2502 with goods, as well as the cuboid corresponding to the storage location showing the space available for storing the pallet and goods. Thus, in such an embodiment, both the cuboid corresponding to the pallet 2502 with goods and the cuboid corresponding to the storage location are shown. The images may be side by side or with the cuboid corresponding to the pallet with goods in front of the cuboid corresponding to the storage location so that an operator can visually see how the pallet with goods can fit inside the storage location represented by the storage location size cuboid.

In step 2486 the cuboids corresponding to the pallet with goods and the storage location are highlighted using colors to indicate areas where a collision, e.g., the right side of the pallet with goods as indicated by reference 3104, is predicted or likely to occur. The cuboids 3002, 2802 can be and sometimes are superimposed on an image captured from the forklift showing the pallet 2502 with payload 2504 in front of the intended storage location with the cuboid 2802 corresponding to the pallet 2502 with goods 2504 being superimposed on the pallet 2502 with goods and the cuboid 3002 corresponding to the available space at storage location 2904 where the pallet 2502 is to be placed being superimposed on an image of the storage location as represented by the image of the rack 2902 in FIG. 32. The sides/top of the cuboids which are not likely to collide in one embodiment are shown in green, sides/top which are predicted to possibly collide are shown in orange and sides/top where collision is predicted are shown in red. This in some embodiments on a single display screen shown to an operator both the pallet 2502 with goods 2504, pallet rack with storage location and corresponding cuboids with color coding to show risk are visible facilitating operator control of the robotic device with the image being updated as the robotic device 300 moves the pallet to reflect the current relative positions of the various elements displayed to the operator.

Operation moves from step 2478 to step 2479 in which the robotic device 300 is controlled based on whether or not it was determined that there is sufficient space at the intended pallet storage location for successful pallet placement, e.g., with this determination having been made in step 2462. In some embodiments if the it was determined that there was sufficient space available for successful pallet with payload placement, the robotic device 300 is controlled to autonomously proceed with pallet placement while if it was determined that there was insufficient space for successful pallet placement, e.g., a failure or collision was likely due to an insufficient space safety margin around the pallet 2502 with goods, operator assistance in controlling placement of the pallet is sought or another placement location having more available space is identified and used, e.g., with autonomous control of the robotic device during pallet placement at the new location. While the robotic device 300 is operating in autonomous mode, a human operator is not involved in controlling the robotic device. Thus, automatic selection of an alternative storage location can be efficient from the perspective of operator time not being required.

Step 2478 in some embodiments beings with step 2488 where a check is made as to whether or not sufficient space was determined to be available at the intended storage location for pallet placement, e.g., automatic pallet placement success or failure was predicted. If sufficient space was not determined to be present, pallet placement failure was predicted and operation proceeds from step 2488 along the no (N) path to step 2494. If in step 2488 it was determined that sufficient space was available for successful pallet placement, operation proceeds from step 2488 along the yes (Y) path to step 2490 in which pallet placement in the storage location automatically proceeds. With the pallet 2502 with goods 2504 having been stored in step 2490, operation proceeds via connecting node F 2492 back to step 2412.

In step 2488 when a failure is predicted, operation proceeds to step 2494 in which the operator is notified of the predicted failure and provided an opportunity to manually control pallet placement, e.g., with the image generated and displayed in step 2478 being intended to help the operator control the pallet placement. In step 2495 a check is made as to whether the operator of the operator workstation 200 decided to proceed with pallet placement under manual control as may be indicated by the operator signaling the robotic device 300 on how to move the pallet 2502 into the intended storage location. If in step 2495 it is determined that the operator will manually control the robotic device 300 to place the pallet 2502 with goods 2504 into the storage location, operation proceeds via the YES path indicated by Y to step 2496 in which the robotic device 300 proceeds to place the pallet 2502 with goods 2504 into the intended storage location under manual operator control. With the pallet having been placed into the intended storage location in step 2496 under manual operator control, operation proceeds from step 2946 via connecting node F 2492 to step 2412 in which the robotic device is provided with instructions to implement another pallet move.

However, if in step 2495 it is determined that the operator has decided not to manually control pallet placement, e.g., as may be indicated by a signal from the operator to find a new storage location, operation proceeds from step 2470 to step 2497 in which the processor of the operator workstation 200 or robotic device 300 identifies, e.g., finds and selects, an alternative storage location with sufficient space for the pallet 2502 with payload 2504. The identified alternative storage location is set in step 2494 to be used as the pallet placement location and operation proceeds via connecting node D 2499 To step 2424 which involves moving the pallet to the intended pallet placement location which in this case will be the alternative location that was selected in step 2497. The movement is followed by the pallet placement related steps which were previously discussed. In such an embodiment where an alternative storage location, e.g., storage location 2908, is selected due to insufficient space at the originally intended storage location and then the robotic device 300 can operate autonomously to move to the newly selected location and store the pallet 2502 with goods 2504, e.g., after automatic checking of the new storage location for sufficient space for pallet storage.

By checking both the pallet 2502 with payload 2504 and the storage area into which the pallet is to be inserted for space, collisions due to shifting of goods during transport or unexpected objects at the storage location where the pallet is to be placed can be detected and collisions avoided.

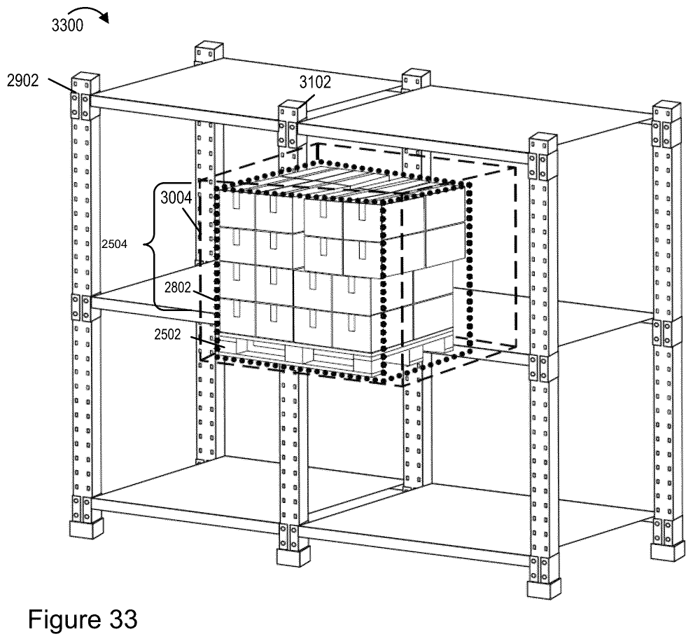

FIG. 33 is a diagram 3300 showing the cuboid 3004 corresponding to storage location 2908 in the top right of the pallet rack 1902 being compared to the cuboid 2802 to make sure the goods will fit in the storage location 2908. The comparison shows that there is space of at least the predetermined amount, e.g., 1 foot in some embodiments, which will avoid a collision on all sides and the top. Accordingly, it is determined that it is safe to automatically place the pallet 2502 and goods 2504 in the alternative storage location 2908. In the example the robotic device 300 will autonomously or under the control of the operator complete the placement of the pallet 2502 with goods 2504 in the storage location 2908 since the space availability check made before insertion of the pallet passed the safety check.

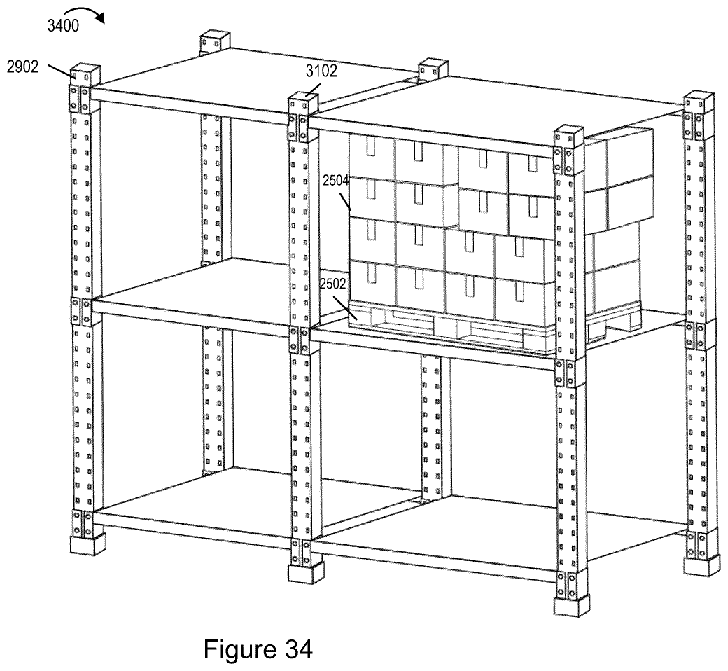

FIG. 34 is a diagram 3400 showing the pallet 2502 with goods 2504 stored, e.g., automatically, after the storage location 2908 is selected as an alternative storage location due to a predicted collision if storage location 2904 was used. As can be seen the pallet 2502 with goods 2504 fits within the storage location 2908 and the collision that would have occurred if the pallet 2502 with shifted goods was inserted into storage location 2904 was avoided.

Numerous variations on the 3D dimensioning, checking and information display are possible while still providing the benefits obtained by the dimensioning and checking operations discussed above.

In the following sets of numbered exemplary embodiments, a reference to a previous numbered embodiment refers to a numbered embodiment in the same set.

### First Set of Exemplary Numbered Method Embodiments

Method Embodiment 1. A method of operating a robotic material handling device (300, 600 or 800) having a string of lights (e.g., light bar 307, 607 or 807) mounted thereon, comprising: collecting (504) sensor data; analyzing (506) the sensor data to detect obstacles; and controlling (520) a group of lights, in the string of lights, corresponding to a direction of a detected obstacle to be illuminated (e.g., light up) to indicate the detection of the detected obstacle.

Method Embodiment 2. The method of Method Embodiment 1, further comprising: determining (514) the direction of the detected obstacle relative to the robotic material handling device.

Method Embodiment 3. The method of Method Embodiment 2, further comprising: determining (510) a distance to the detected obstacle; and determining (512) a number of lights (e.g., the number of adjacent lights facing in the direction of the obstacle which form the group of lights that is illuminated) to be illuminated due to the detection of the obstacle based on the determined distance to the obstacle.

Method Embodiment 3A. The method of Method Embodiment 3, wherein the determined number of lights is greater when the detected distance is a first distance than when the detected distance is a second distance, said first distance being smaller than the second distance (e.g., the closer the detected object is the larger the number of lights which are illuminated to indicate detection of the object).

Method Embodiment 4. The method of Method Embodiment 3, further comprising: determining the type of obstacle which was detected (e.g., human or inanimate object).

Method Embodiment 5. The method of Method Embodiment 4, further comprising: determining (518) a color to be used for at least one of the lights in the group of lights to indicate the type of object which was detected.

Method Embodiment 6. The method of Method Embodiment 5, wherein controlling (520) the group of lights, in the string of lights, corresponding to the direction of the detected obstacle to be illuminated includes: controlling at least one light in the group of lights to be illuminated in the determined color.

Method Embodiment 7. The method of Method Embodiment 6, where the determined color is a first color (e.g., red) when the detected object is determined to be a human and a second color (e.g., orange) when the determined object is determined to be a non-human object.

Method Embodiment 8. The method of Method Embodiment 3, wherein said string of lights includes lights mounted on of a front, rear, left and right side of the robotic material handling vehicle.

Method Embodiment 9. The method of Method Embodiment 3, wherein said robotic material handling vehicle is a robotic forklift capable of operating without a human operator present in the robotic material handling vehicle, said string of lights being an obstacle detected indicator light bar (307).

Method Embodiment 10. The method of Method Embodiment 9, wherein said obstacle detected indicator light bar (307) extends around a canopy of said robotic material handling vehicle.

Method Embodiment 10A. The method of Method Embodiment 9, wherein said obstacle detected indicator light bar (307 or 807 which includes light bar portions 807′, 807″, 807″′ and 807″″) extends around a main body portion (802) of the robotic material handling vehicle.

### First Set of Exemplary Numbered Apparatus Embodiments

Apparatus Embodiment 1. A robotic material handling device (300, 600 or 800) comprising: one or more sensors (370, 372, 374, 376, 392, 394); a string of lights (e.g., light bar 307, 607 or 807); and a processor (399) configured to: collect (504) sensor data; analyze (506) the sensor data to detect obstacles; and control (520) a group of lights, in the string of lights, corresponding to a direction of a detected obstacle to be illuminated (e.g., light up) to indicate the detection of the detected obstacle.

Apparatus Embodiment 2. The robotic material handling device (300, 600 or 800) of Apparatus Embodiment 1, wherein the processor (399) is further configured to:
determine (514) the direction of the detected obstacle relative to the robotic material handling device.

Apparatus Embodiment 3. The robotic material handling device (300, 600 or 800) method of Apparatus Embodiment 2, wherein the processor (399) is further configured to: determine (510) a distance to the detected obstacle; and determine (512) a number of lights (e.g., the number of adjacent lights facing in the direction of the obstacle which form the group of lights that is illuminated) to be illuminated due to the detection of the obstacle based on the determined distance to the obstacle.

Apparatus Embodiment 3A. The robotic material handling device (300, 600 or 800) of Apparatus Embodiment 3 wherein the determined number of lights is greater when the detected distance is a first distance than when the detected distance is a second distance, said first distance being smaller than the second distance (e.g., the closer the detected object is the larger the number of lights which are illuminated to indicate detection of the object).

Apparatus Embodiment 4. The robotic material handling device (300, 600 or 800) of Apparatus Embodiment 3, wherein the processor (399) is further configured to: determine the type of obstacle which was detected (e.g., human or inanimate object).

Apparatus Embodiment 5. The robotic material handling device (300, 600 or 800) of Apparatus Embodiment 4, wherein the processor is further configured to: determine (518) a color to be used for at least one of the lights in the group of lights to indicate the type of object which was detected.

Apparatus Embodiment 6. The robotic material handling device (300, 600 or 800) of Apparatus Embodiment 5, wherein controlling (520) the group of lights, in the string of lights, corresponding to the direction of the detected obstacle to be illuminated includes: controlling at least one light in the group of lights to be illuminated in the determined color.

Apparatus Embodiment 7. The robotic material handling device (300, 600 or 800) of Apparatus Embodiment 6, where the determined color is a first color (e.g., red) when the detected object is determined to be a human and a second color (e.g., orange) when the determined object is determined to be a non-human object.

Apparatus Embodiment 8. The robotic material handling device (300, 600 or 800) of Apparatus Embodiment 3, wherein said string of lights includes lights mounted on of a front, rear, left and right side of the robotic material handling vehicle.

Apparatus Embodiment 9. The robotic material handling device (300, 600 or 800) of Apparatus Embodiment 3, wherein said robotic material handling vehicle is a robotic forklift capable of operating without a human operator present in the robotic material handling vehicle, said string of lights being an obstacle detected indicator light bar (307).

Apparatus Embodiment 10. The robotic material handling device (300, 600 or 800) of Apparatus Embodiment 9, wherein said obstacle detected indicator light bar (307 or 607 including light string portions 607′, 607″, 607″′ and 607″″) extends around a canopy 620 of said robotic material handling vehicle.

Apparatus Embodiment 10A. The robotic material handling device (300, 600 or 800) of Apparatus Embodiment 9, wherein said obstacle detected indicator light bar (307 or 807 which includes light bar portions 807′, 807″, 807″′ and 807″″) extends around a main body portion (802) of the robotic material handling vehicle.

### First Set of Exemplary Numbered Non-Transitory Computer Readable Medium Embodiments

Non-Transitory Computer Readable Medium Embodiment 1. A non-transitory computer readable medium including processor executable instruction which when executed by a processor (399) of a robotic material handling device (300, 600 or 800) having a string of lights (e.g., light bar 307, 607 or 807) mounted thereon, controls the robotic material handling vehicle to: collect (504) sensor data; analyze (506) the sensor data to detect obstacles; and control (520) a group of lights, in the string of lights, corresponding to a direction of a detected obstacle to be illuminated (e.g., light up) to indicate the detection of the detected obstacle.

### Second Set of Exemplary Numbered Method Embodiments

Method Embodiment 1. A method of controlling a robotic material handling device (300, 600 or 800) comprising: controlling the robotic material handling device (300, 600 or 800) to perform a first pallet pickup operation (1022) to pick up a pallet (1314); and determining (1024) from the output of a pallet position sensor (305) on the robotic material handling device (300, 600 or 800) if the pallet (1314) is nested on forks (323, 325) of the robotic material handling device (300, 600 or 800).

Method Embodiment 2. The method of Method Embodiment 1, further comprising: controlling the robotic material handling device, in response to determining (1024) from the output of the pallet position sensor (305) that the pallet (1314) is not nested on the forks (323, 325) (e.g., no output of step 1024), to move (1016) the pallet (1314) closer to the robotic material handling device while the pallet (1314) is in the air on the forks (323, 325) due to the first pallet pickup; controlling the robotic material handling device to deposit (1018) the pallet (1314) (e.g., on the ground or surface from which the pallet was first picked up but now at a position closer to the robotic material handling device); and controlling the robotic material handling device (300, 600 or 800) to perform a second pallet pickup operation (1020) to pick up the pallet (1314) for a second time.

Method Embodiment 3. The method of Method Embodiment 2, further comprising: determining (1024), after the second pallet pickup operation (1020), from the output of the pallet position sensor (305) on the robotic material handling device (300, 600 or 800) if the pallet (1314) is nested on forks (323, 325) of the robotic material handling device (300, 600 or 800).

Method Embodiment 4. The method of Method Embodiment 3, further comprising: in response to determining (1024), after the second pallet pickup operation (1020), that the pallet (1314) is nested on forks (323, 325), transporting (1026) the pallet (1314) to a pallet destination.

Method Embodiment 5. The method of Method Embodiment 1, wherein said pallet position sensor (305) is mounted at a fixed position on a fork backrest that will move with the forks as the forks are extended or retracted (e.g., at a fixed position relative to a front surface of a vertical backrest member of the backrest which will contact a pallet when the pallet is fully nested on the forks), said fixed position being constant in some embodiments relative to the location of the tips of the pallet forks allowing for accurate measurement of how far the pallet is inserted into the forks based on the distance measured between the sensor and the pallet.

Method Embodiment 6. The method of Method Embodiment 5, wherein said pallet position sensor is a non-contact distance measuring device (e.g., an ultrasonic distance measuring device in some embodiments).

Method Embodiment 7. The method of Method Embodiment 6, wherein said pallet position sensor is mounted on a member of the fork backrest positioned at a location which is between the forks.

Method Embodiment 8. The method of Method Embodiment 7 wherein the pallet position sensor (305) is mounted above a forward looking camera array 392 which has a field of view including the pallet forks.

Method Embodiment 9. The method of Method Embodiment 4, further comprising: receiving (1004) an instruction to move the pallet (1314) to the pallet destination; determining (1006) the location of the pallet (1314) to be moved; determining (1008) a safe forklift placement location from which to pick the pallet to be moved; controlling the robotic material handling device to move (1010) to the determined forklift placement location prior to proceeding with lifting of the pallet (1314) (with in some cases the first and second pallet lifts being performed while the robotic material handling device remains stationary (e.g., parked) at the forklift placement position).

Method Embodiment 10. The method of Method Embodiment 1, wherein the robotic material handling device (300, 600 or 800) is a robotic forklift capable of operating in a fully autonomous mode in which the processor (399) controls the robotic device to perform the recited steps.

### Second Set of Exemplary Numbered Apparatus Embodiments

Apparatus Embodiment 1. A robotic material handling device (300, 600 or 800) comprising: a fork assembly (379) including a backrest 321, a first fork 323 and a second fork 325; a pallet position sensor 305; and a processor (399) coupled to the pallet position sensor (305) configured to control the robotic material handling device (300, 600 or 800) to: perform a first pallet pickup operation (1022) to pick up a pallet (1314); and determine (1024) from the output of a pallet position sensor (305) on the robotic material handling device (300, 600 or 800) if the pallet (1314) is nested on forks (323, 325) of the robotic material handling device (300, 600 or 800).

Apparatus Embodiment 2. The robotic material handling device (300, 600 or 800) of Apparatus Embodiment 1, wherein the processor (399) is further configured to control the robotic material handling device (300, 600 or 800) to: move (1016) the pallet (1314) closer to the robotic material handling device while the pallet (1314) is in the air on the forks (323, 325) due to the first pallet pickup, in response to determining (1024) from the output of the pallet position sensor (305) that the pallet (1314) is not nested on the forks (323, 325) (e.g., no output of step 1024); deposit (1018) the pallet (1314) (e.g., on the ground or surface from which the pallet was first picked up but now at a position closer to the robotic material handling device); and perform a second pallet pickup operation (1020) to pick up the pallet (1314) for a second time.

Apparatus Embodiment 3. The robotic material handling device (300, 600 or 800) of Apparatus Embodiment 2, further comprising: determining (1024), after the second pallet pickup operation (1020), from the output of the pallet position sensor (305) on the robotic material handling device (300, 600 or 800) if the pallet (1314) is nested on forks (323, 325) of the robotic material handling device (300, 600 or 800).

Apparatus Embodiment 4. The robotic material handling device (300, 600 or 800) of Apparatus Embodiment 3, further comprising: in response to determining (1024), after the second pallet pickup operation (1020), that the pallet (1314) is nested on forks (323, 325), transporting (1026) the pallet (1314) to a pallet destination.

Apparatus Embodiment 5. The robotic material handling device (300, 600 or 800) of Apparatus Embodiment 1, wherein said pallet position sensor (305) is mounted at a fixed position on a fork backrest that will move with the forks as the forks are extended or retracted (e.g., at a fixed position relative to a front surface of a vertical backrest member of the backrest which will contact a pallet when the pallet is fully nested on the forks), said fixed position being constant in some embodiments relative to the location of the tips of the pallet forks allowing for accurate measurement of how far the pallet is inserted into the forks based on the distance measured between the sensor and the pallet).

Apparatus Embodiment 6. The robotic material handling device (300, 600 or 800) of Apparatus Embodiment 5, wherein said pallet position sensor is a non-contact distance measuring device (e.g., an ultrasonic distance measuring device in some embodiments).

Apparatus Embodiment 7. The robotic material handling device (300, 600 or 800) of Apparatus Embodiment 6, wherein said pallet position sensor is mounted on a member of the fork backrest positioned at a location which is between the forks.

Apparatus Embodiment 8. The robotic material handling device (300, 600 or 800) of Apparatus Embodiment 7 wherein the pallet position sensor (305) is mounted above a forward looking camera array 392 which has a field of view including the pallet forks.

Apparatus Embodiment 9. The robotic material handling device (300, 600 or 800) of Apparatus Embodiment 4, further comprising: receiving (1004) an instruction to move the pallet (1314) to the pallet destination; determining (1006) the location of the pallet (1314) to be moved; determining (1008) a safe forklift placement location from which to pick the pallet to be moved; and controlling the robotic material handling device to move (1010) to the determined forklift placement location prior to proceeding with lifting of the pallet (1314) (with in some cases the first and second pallet lifts being performed while the robotic material handling device remains stationary (e.g., parked) at the forklift placement position).

### Second Set of Numbered Non-Transitory Computer Readable Medium Embodiments

Non-Transitory Computer Readable Medium Embodiment 1. A non-transitory computer readable medium which, when executed by a processor (e.g., processor 399) in a robotic material handling device (300, 600 or 800) control the robotic material handling device to: perform a first pallet pickup operation (1022) to pick up a pallet (1314); and determine (1024) from the output of a pallet position sensor (305) on the robotic material handling device (300, 600 or 800) if the pallet (1314) is nested on forks (323, 325) of the robotic material handling device (300, 600 or 800).

### Third Set of Exemplary Numbered Method Embodiments

Method Embodiment 1. A method of controlling a robotic device (300), the method comprising: controlling the robotic device to move (2414) to a pallet pickup location (e.g., under the control of instructions communicated by a control device such as operator workstation 200 and received by the robotic device in step 2412); capturing (2416) (e.g., at the pallet pickup location) a first set of sensor data providing 3D information corresponding to a pallet 2502 with payload 2504 (e.g., images captured by cameras of a camera system (e.g., forward looking camera system 392) which includes multiple cameras spaced apart from one another to support stereoscopic depth and/or shape determinations which are generated from images captured by the cameras of the camera system or LIDA, RADA or SONAR sensor data providing 3D information about the pallet and payload); and generating (2418 3D representation of pallet 2502 with payload 2504 before moving or 2428 3D representation of pallet with payload after move) a 3D representation of the pallet 2502 with payload 2504 from captured sensor data.

Method Embodiment 2. The method of Method Embodiment 1, further comprising: capturing (2452) (e.g., at a location in front of a storage rack into which the pallet 2502 with payload 2504 is inserted) a set of sensor data providing 3D information corresponding to a pallet storage location; (e.g., images captured by cameras of the camera system (e.g., forward looking camera system 392) which includes multiple cameras spaced apart from one another to support stereoscopic depth and/or shape determinations which are generated from images captured by the cameras of the camera system or LIDA, RADA or SONAR sensor data providing 3D information about the pallet and payload); generating (2454) a 3D representation of the available storage space at the pallet placement location from captured sensor data; and determining (2462) if there is sufficient space at the pallet placement location for successful pallet placement (e.g., determine if the robotic device 300 is likely to succeed or will succeed with placement of the pallet 2502 with goods 2504, e.g., autonomously without operator assistance), said determining including comparing (2464) the generated 3D shape corresponding to the pallet 2502 with the payload 2504 to the generated 3D shape corresponding to the available storage space at the pallet placement location.

Method Embodiment 3. The method of Method Embodiment 2, further comprising: controlling (2478) robotic device (300) operation based on the determination (2462) of whether or not there is sufficient space at the pallet placement location for successful pallet placement.

Method Embodiment 4. The method of Method Embodiment 3, wherein capturing (2416) a first set of sensor data providing 3D information corresponding to a pallet 2502 with payload 2504 includes capturing a first set of images using cameras of a stereoscopic camera array (392); and wherein generating a 3D representation of the pallet 2502 with payload 2504 from captured sensor data includes processing the captured images to generate a 3D shape or model corresponding toe the pallet with payload.

Method Embodiment 5. The method of Method Embodiment 4, wherein generating (2418) a 3D representation of the pallet 2502 with payload 2504 from captured sensor data includes processing the captured images to generate (2422) a cuboid shape corresponding to the perimeter of the pallet 2502 with payload 2504.

Method Embodiment 6. The method of Method Embodiment 5, wherein capturing (2452) a set of sensor data providing 3D information corresponding to the pallet storage location includes capturing a set of images of the pallet storage location using cameras of the stereoscopic camera array.

Method Embodiment 7. The method of Method Embodiment 6, wherein generating (2454) a 3D representation of the available storage space at the pallet placement location from captured sensor data includes generating (2458) a cuboid shape corresponding to the available space at the pallet placement location.

Method Embodiment 8. The method of Method Embodiment 7, wherein determining (2462) if there is sufficient space at the pallet placement location for successful pallet placement includes: comparing (2464) the cuboid shape corresponding to the perimeter of the pallet 2502 with payload 2504 to the cuboid shape corresponding to the available space at the pallet placement location.

Method Embodiment 9. The method of Method Embodiment 7, wherein determining (2462) if there is sufficient space at the pallet placement location for successful pallet placement includes: determining (2470) if the cuboid shape corresponding to the perimeter of the pallet 2502 with payload 2504 first with the cuboid shape corresponding to the available space at the pallet placement location by at least a predetermined amount (e.g., 1 foot, 6 inches or some other amount expressed as a distance) on the top, left side, right side and front portions of the cuboid shape corresponding to the perimeter of the pallet 2502 with payload 2504.

Method Embodiment 10. The method of Method Embodiment 9, further comprising: displaying on an operator workstation 200 an image 3200 of the pallet placement location 2904 along with the cuboid 2802 corresponding to the pallet 2502 with payload 2504 with a visual indication 3104 of a predicted collision area if the pallet 2502 is inserted into the pallet placement location 2904.

Method Embodiment 10A. The method of Method Embodiment 10 wherein the visual indication 3104 includes coloring a side of the cuboid 2802 corresponding to the pallet 2502 with payload 2504 red on the side 3104 where the collision will occur.

Method Embodiment 10B. The method of Method Embodiment 10A, wherein displaying on the operator workstation 200 the image 3200 of the pallet placement location 2904 along with the cuboid 2802 corresponding to the pallet 2502 with payload 2504 includes coloring cuboid areas (e.g., left, front top, front bottom, which are not predicted to be subject to a collision green.

Method Embodiment 10C. The method of Method Embodiment 4, wherein the robotic device 300 is a robotic forklift which supports an autonomous mode of operation and an operator controlled mode of operation; and wherein controlling (2478) robotic device (300) operation based on the determination (2462) of whether or not there is sufficient space at the pallet placement location for successful pallet placement includes: when it is determined there is sufficient space at the pallet storage location for storing the pallet 2502 with goods 2504 in the storage location, operating (2490) in an autonomous mode of robotic device operation to store the pallet 2502 with goods 2504 when there is sufficient space at the pallet placement location for successful pallet placement; and when it is determined there is not sufficient space at the pallet storage location for storing the pallet 2502 with goods 2504 in the storage location, operating (2496) the robotic device 300 under operator control to store the pallet 2502 with goods 2504 in said storage location or operating (2498) the robotic device 300 in an autonomous mode of operation to store the pallet 2502 with payload 2504 in an alternative storage location.

Method Embodiment 11. The method of Method Embodiment 3, further comprising: capturing (2426) (e.g., at the pallet placement location) a second set of sensor data providing 3D information corresponding to the pallet 2502 with payload 2504 following the move (e.g., images captured by cameras of a camera system (e.g., forward looking camera system 392) which includes multiple cameras spaced apart from one another to support stereoscopic depth and/or shape determinations which are generated from images captured by the cameras of the camera system or LIDA, RADA or SONAR sensor data providing 3D information about the pallet and payload); and generating (2428 3D representation of pallet with payload after move) a second 3D representation of the pallet 2502 with payload 2504 from captured sensor data; and comparing (2436) the first and second 3D representations of the pallet 2502 with payload 2504 to determine an amount of any shift in payload during moving of the pallet from the pickup location.

Method Embodiment 12. The method of Method Embodiment 11, further comprising: determining (2442) if a shift in payload which occurred while moving the pallet 2502 with payload 2504 is likely to result in failure of pallet placement (e.g., into the intended storage location).

Method Embodiment 13. The method of Method Embodiment 12, wherein determining (2442) if a shift in payload which occurred while moving the pallet 2502 with payload 2504 is likely to result in failure of placement of the pallet 2502 with goods 2504 (e.g., into the intended storage location).

Method Embodiment 13A. The method of Method Embodiment 13, wherein determining (2442) if a shift in payload which occurred while moving the pallet 2502 with payload 2504 is likely to result in failure of placement of the pallet 2502 with goods 2504 includes determining (2444) if a shift in goods over the edge of the pallet 2502 by a predetermined amount (e.g., 6 inches) occurred during the move from the pickup location.

Method Embodiment 14. The method of Method Embodiment 13, further comprising: in response to determining (2442) that a shift in payload which occurred while moving the pallet 2502 with payload 2504 is likely to result in failure of placement of the pallet 2502 with goods 2504, transporting the pallet 2502 with payload 2504 to an inspection area, a repacking area or inspection and repacking area prior to placement of the pallet 2502 with goods 2504 in a pallet storage location.

Method Embodiment 14A. The method of Method Embodiment 14, further comprising: subjecting (2448) the pallet 2502 with payload 2504 to an inspection, restacking and/or repacking of goods operation to change the arrangement of goods on the pallet 2502 to avoid goods extending over the edge of the pallet 2502.

### This Set of Apparatus/System Embodiments

Apparatus Embodiment 1. A system for controlling the movement of one or more pallets, the system comprising: a robotic forklift device (300); one or more processors (202, 306) configured to control the robotic device to: move (2414) to a pallet pickup location (e.g., under the control of instructions communicated by a control device such as operator workstation 200 and received by the robotic device in step 2412); capture (2416) (e.g., at the pallet pickup location) a first set of sensor data providing 3D information corresponding to a pallet 2502 with payload 2504 (e.g., images captured by cameras of a camera system (e.g., forward looking camera system 392) which includes multiple cameras spaced apart from one another to support stereoscopic depth and/or shape determinations which are generated from images captured by the cameras of the camera system or LIDA, RADA or SONAR sensor data providing 3D information about the pallet and payload); and generate (2418 3D representation of pallet 2502 with payload 2504 before moving or 2428 3D representation of pallet with payload after move) a 3D representation of the pallet 2502 with payload 2504 from captured sensor data.

Apparatus Embodiment 2. The system of Apparatus Embodiment 1, wherein the one or more processors (202, 306) are further configured to: control the robotic device (300) to capture (2452) (e.g., at a location in front of a storage rack into which the pallet 2502 with payload 2504 is inserted) a set of sensor data providing 3D information corresponding to a pallet storage location; (e.g., images captured by cameras of the camera system (e.g., forward looking camera system 392) which includes multiple cameras spaced apart from one another to support stereoscopic depth and/or shape determinations which are generated from images captured by the cameras of the camera system or LIDA, RADA or SONAR sensor data providing 3D information about the pallet and payload); generate (2454) a 3D representation of the available storage space at the pallet placement location from captured sensor data; and determine (2462) if there is sufficient space at the pallet placement location for successful pallet placement (e.g., determine if the robotic device 300 is likely to succeed or will succeed with placement of the pallet 2502 with goods 2504, e.g., autonomously without operator assistance), said determining including comparing (2464) the generated 3D shape corresponding to the pallet 2502 with the payload 2504 to the generated 3D shape corresponding to the available storage space at the pallet placement location.

Apparatus Embodiment 3. The system of Apparatus Embodiment 2, wherein the one or more processors (202, 306) are further configured to: control (2478) robotic device (300) operation based on the determination (2462) of whether or not there is sufficient space at the pallet placement location for successful pallet placement.

Apparatus Embodiment 4. The system of Apparatus Embodiment 3, wherein capturing (2416) a first set of sensor data providing 3D information corresponding to a pallet 2502 with payload 2504 includes capturing a first set of images using cameras of a stereoscopic camera array (392); and wherein generating a 3D representation of the pallet 2502 with payload 2504 from captured sensor data includes processing the captured images to generate a 3D shape or model corresponding to the pallet 2502 with payload 2504.

Apparatus Embodiment 5. The system of Apparatus Embodiment 4, wherein generating (2418) a 3D representation of the pallet 2502 with payload 2504 from captured sensor data includes operating the one or more processors to process the captured images to generate (2422) a cuboid shape corresponding to the perimeter of the pallet 2502 with payload 2504.

Apparatus Embodiment 6. The system of Apparatus Embodiment 5, wherein the robotic device (300) further includes a camera array (392) and wherein controlling the robotic device to capture (2452) a set of sensor data providing 3D information corresponding to the pallet storage location includes controlling the robotic device to capture a set of images of the pallet storage location using cameras of the stereoscopic camera array.

Apparatus Embodiment 7. The system of Apparatus Embodiment 6, wherein operating the one or more processors (202, 306) to generate (2454) a 3D representation of the available storage space at the pallet placement location from captured sensor data includes operating the one or more processors to generate (2458) a cuboid shape corresponding to the available space at the pallet placement location.

Apparatus Embodiment 8. The system of Apparatus Embodiment 7, wherein operating the one or more processors (202, 306) to determine (2462) if there is sufficient space at the pallet placement location for successful pallet placement includes: operating the one or more processors (202, 306) to compare (2464) the cuboid shape corresponding to the perimeter of the pallet 2502 with payload 2504 to the cuboid shape corresponding to the available space at the pallet placement location.

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, implemented using a variety of wireless communications technologies such as CDMA, orthogonal frequency division multiplexing (OFDM), WiFi, and/or various other types of communications techniques which may be used to provide wireless communications links.

Some aspects and/or features are directed to a non-transitory computer readable medium embodying a set of software instructions, e.g., computer executable instructions, for controlling a computer or other device, e.g., a vehicle such as a forklift or other robotic device or an operator workstation, to operate in accordance with the above discussed methods.

The techniques of various embodiments may be implemented using software, hardware and/or a combination of software and hardware. Various embodiments are directed to a control apparatus, e.g., controller or control system, which can be implemented using a microprocessor including a CPU, memory and one or more stored instructions for controlling a device or apparatus to implement one or more of the above described steps. Various embodiments are also directed to methods, e.g., a method of controlling a device, e.g., a forklift or other robotic device, or an operator workstation and/or performing one or more of the other operations described in the present application. Various embodiments are also directed to a non-transitory machine, e.g., computer, readable medium, e.g., ROM, RAM, CDs, hard discs, etc., which include machine readable instructions for controlling a machine to implement one or more steps of a method.

As discussed above various features of the present invention are implemented using modules and/or components. Such modules and/or components may, and in some embodiments are, implemented as software modules and/or software components. In other embodiments the modules and/or components are implemented in hardware. In still other embodiments the modules and/or components are implemented using a combination of software and hardware. In some embodiments the modules and/or components are implemented as individual circuits with each module and/or component being implemented as a circuit for performing the function to which the module and/or component corresponds. A wide variety of embodiments are contemplated including some embodiments where different modules and/or components are implemented differently, e.g., some in hardware, some in software, and some using a combination of hardware and software. It should also be noted that routines and/or subroutines, or some of the steps performed by such routines, may be implemented in dedicated hardware as opposed to software executed on a general purpose processor. Such embodiments remain within the scope of the present invention. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods. Accordingly, among other things, the present invention is directed to a machine-readable medium including machine executable instructions for causing a machine, e.g., processor and associated hardware, to perform one or more of the steps of the above-described method(s).

The techniques of the present invention may be implemented using software, hardware and/or a combination of software and hardware. The present invention is directed to apparatus, e.g., a vehicle which implements one or more of the steps of the present invention. The present invention is also directed to machine readable medium, e.g., ROM, RAM, CDs, hard discs, etc., which include machine readable instructions for controlling a machine to implement one or more steps in accordance with the present invention.

Numerous additional variations on the methods and apparatus of the various embodiments described above will be apparent to those skilled in the art in view of the above description. Such variations are to be considered within the scope.

What is claimed:

1. A method of operating a robotic material handling device having a string of lights mounted thereon, comprising:
collecting sensor data;
analyzing the sensor data to detect obstacles; and
controlling a group of lights, in the string of lights, corresponding to a direction of a detected obstacle to be illuminated to indicate the detection of the detected obstacle.

2. The method of claim 1, further comprising:
determining the direction of the detected obstacle relative to the robotic material handling device.

3. The method of claim 2, further comprising:
determining a distance to the detected obstacle; and
determining a number of lights to be illuminated due to the detection of the obstacle based on the determined distance to the obstacle.

4. The method of claim 3, further comprising:
determining the type of obstacle which was detected.

5. The method of claim 4, further comprising:
determining a color to be used for at least one of the lights in the group of lights to indicate the type of object which was detected.

6. The method of claim 5, wherein controlling the group of lights, in the string of lights, corresponding to the direction of the detected obstacle to be illuminated includes:
controlling at least one light in the group of lights to be illuminated in the determined color.

7. The method of claim 6,
wherein said type of object detected is one of i) a human being object type or ii) an inanimate object type; and
where the determined color is a first color when the detected object is determined to be a first color when the detected object is a human, said human being object type being used for objects which are human beings and a second color when the determined object is determined to be an inanimate object type, said inanimate object type being used for objects that are not human beings.

8. The method of claim 3, wherein said string of lights includes lights mounted on of a front, rear, left and right side of the robotic material handling vehicle.

9. The method of claim 3, wherein said robotic material handling vehicle is a robotic forklift capable of operating without a human operator present in the robotic material handling vehicle, said string of lights being an obstacle detected indicator light bar.

10. The method of claim 9, wherein said obstacle detected indicator light bar extends around a canopy of said robotic material handling vehicle.

11. A robotic material handling device comprising:
one or more sensors;
a string of lights; and
a processor configured to:
collect sensor data;
analyze the sensor data to detect obstacles; and
control a group of lights, in the string of lights, corresponding to a direction of a detected obstacle to be illuminated to indicate the detection of the detected obstacle.

12. The robotic material handling device of claim 11, wherein the processor is further configured to:
determine the direction of the detected obstacle relative to the robotic material handling device.

13. The robotic material handling device method of claim 12, wherein the processor is further configured to:
determine a distance to the detected obstacle; and
determine a number of lights to be illuminated due to the detection of the obstacle based on the determined distance to the obstacle.

14. The robotic material handling device of claim 13, wherein the processor is further configured to:
determine the type of obstacle which was detected.

15. The robotic material handling device of claim 14, wherein the processor is further configured to:
determine a color to be used for at least one of the lights in the group of lights to indicate the type of object which was detected.

16. The robotic material handling device of claim 15, wherein controlling the group of lights, in the string of lights, corresponding to the direction of the detected obstacle to be illuminated includes:
controlling at least one light in the group of lights to be illuminated in the determined color.

17. The robotic material handling device of claim 16, where the determined color is a first color when the detected object is determined to be a human and a second color when the determined object is determined to be a non-human object.

18. The robotic material handling device of claim 13, wherein said string of lights includes lights mounted on of a front, rear, left and right side of the robotic material handling vehicle.

19. The robotic material handling device of claim 13, wherein said robotic material handling vehicle is a robotic forklift capable of operating without a human operator present in the robotic material handling vehicle, said string of lights being an obstacle detected indicator light bar.

20. A non-transitory computer readable medium including processor executable instruction which when executed by a processor of a robotic material handling device having a string of lights mounted thereon, controls the robotic material handling vehicle to:
collect sensor data;
analyze the sensor data to detect obstacles; and
control a group of lights, in the string of lights, corresponding to a direction of a detected obstacle to be illuminated to indicate the detection of the detected obstacle.
